(19) United States
(12) Patent Application Publication
(10) Pub. No.: US 2026/0099672 A1
(43) Pub. Date: Apr. 9, 2026

(54) Efficient Hybrid Generative AI via Context Filtering/Focused Attention

(71) Applicant: QUALCOMM Incorporated, San Diego, CA (US)

(72) Inventors: Tien Viet NGUYEN, Bridgewater, NJ (US); Qi XUE, San Diego, CA (US); Oguzhan BASER, Somerset, NJ (US); June NAMGOONG, San Diego, CA (US); Jeya Pradha JEYARAJ, San Diego, CA (US); Kapil GULATI, Belle Mead, NJ (US); Gene Wesley MARSH, San Diego, CA (US); Shailesh PATIL, San Diego, CA (US); Junyi LI, Greentown, PA (US); Bibhu MOHANTY, Del Mar, CA (US)

(21) Appl. No.: 18/909,641

(22) Filed: Oct. 8, 2024

(51) Int. Cl. G06F 40/284; G06F 3/01

(52) U.S. Cl. CPC G06F 40/284; G06F 3/013

(57) ABSTRACT

Various embodiments include systems and methods for performing efficient hybrid AI processing. A computing system may be configured to receive multimodal data, determine user intent based on information available to the processor, generate filtered input data by performing context filtering on the multimodal data based on the determined user intent, generate data segments by segmenting the filtered input data based on the determined user intent, and convert the data segments into tokens representing attributes of the data segments. The computing system may assign a priority to each of the tokens based on their relevance to the determined user intent, generate an enhanced prompt based on the assigned token priorities, send the enhanced prompt to an artificial intelligence (AI) model, receive inference results from the AI model, generate a final output based on the received inference results and locally processed data, and present the final output to a user.

### BACKGROUND

Recent advancements in artificial intelligence (AI) and machine learning (ML) have led to the development of increasingly sophisticated models capable of processing and interpreting complex data structures. These models, commonly known as generative AI models (XM) or large generative AI models (LXMs), are now central to many applications, including virtual assistants, automated content generation, natural language processing, computer vision, and speech recognition. Due to their computational intensity, these models are typically deployed in cloud-based environments that provide substantial processing power and storage capacity. However, as more mobile and IoT devices integrate AI capabilities, there is a growing need to distribute processing tasks between local devices and the cloud. This distributed approach may enhance efficiency, reduce costs, and enable faster response times.

The shift towards distributed AI processing may be complicated by the rise in multimodal data processing, which involves handling diverse inputs such as audio, visual, and text data. Processing such multimodal data may require advanced and context-sensitive techniques that present new challenges in effectively managing and using the data. Tokenized multimodal data processing has emerged as a promising approach to address these technical challenges.

### SUMMARY

Various aspects include methods performed by a processor of an end-user computing device of applying multimodal data to an artificial intelligence (AI) model, which may include receiving multimodal data, determining user intent based on information available to the processor, generating filtered input data by performing context filtering on the multimodal data based on the determined user intent, generating data segments by segmenting the filtered input data based on the determined user intent, converting the data segments into tokens representing attributes of the data segments, assigning a priority to each of the tokens based on their relevance to the determined user intent, generating an enhanced prompt based on the assigned token priorities, sending the enhanced prompt to an AI model, receiving inference results from the AI model, generating a final output based on the received inference results and locally processed data (i.e., data processed by at least one processor of the computing device), and presenting the final output to a user.

In some aspects, assigning a priority to each of the tokens based on their relevance to the determined user intent may include generating a bitmap indicating the importance of each token, the generated bitmap including at least one of a hard bitmap that may include binary values or a soft bitmap that may include a range of values, and generating an enhanced prompt based on the assigned token priorities may include selecting tokens for transmission based on the generated bitmap and a dynamically updated threshold value for token transmission.

Some aspects may further include adjusting the dynamically updated threshold value based on at least one of battery life, network bandwidth, computational resources, or communication costs. In some aspects, receiving the multimodal data may include receiving at least two or more of visual data, auditory data, textual data, or sensor data. In some aspects, generating the data segments by segmenting the filtered input data based on the determined user intent may include generating bounding boxes around specific objects of interest within visual data based on the determined user intent.

Some aspects may further include compressing context data to reduce a data size of the context data in response to determining that a large volume of the context data is relevant to the determined user intent, in which generating the enhanced prompt based on the assigned token priorities may include generating the enhanced prompt based on the assigned token priorities and the compressed context data. In some aspects, generating the final output may include integrating the inference results with locally collected context information and user profile information. In some aspects, presenting the final output to the user may include at least one of displaying information on an electronic display of the end-user device, providing audio feedback, or performing a responsive action.

Some aspects may further include monitoring user interactions with the end-user device to collect attention-based metrics and feedback data, and updating user profile information or context information based on the collected attention-based metrics and feedback data. Some aspects may further include adjusting operations of the end-user device based on the updated user profile information or the updated context information.

In some aspects, determining the user intent based on the information available to the processor may further include deriving the user intent from sensory data obtained from one or more input devices. In some aspects, deriving the user intent from the sensory data obtained from one or more input devices may include deriving the user intent from gaze detection data obtained from augmented reality (AR) glasses worn by the user.

In some aspects, sending the enhanced prompt to the AI model and receiving the inference results from the AI model may include sending the enhanced prompt to a cloud-based AI model and receiving the inference results from the cloud-based AI model. In some aspects, sending the enhanced prompt to the AI model and receiving the inference results from the AI model include sending the enhanced prompt to a local AI model and receiving the inference results from the local AI model.

Further aspects may include a computing device having at least one processor coupled to memory and configured with processor-executable instructions to perform various operations corresponding to the methods summarized above. Further aspects may include a non-transitory processor-readable storage medium having stored thereon processor-executable instructions configured to cause at least one processor to perform various operations corresponding to the method operations summarized above. Further aspects may include a computing device having various means for performing functions corresponding to the method operations summarized above.

### BRIEF DESCRIPTION OF THE DRAWINGS

The accompanying drawings, which are incorporated herein and constitute part of this specification, illustrate exemplary embodiments of the claims and, together with the general description given and the detailed description, serve to explain the features herein.

FIG. 1A is a component block diagram illustrating example components in a system in package (SIP) that may be included in a computing device and configured to implement some embodiments.

FIG. 1B is a component block diagram illustrating an example computing system architecture that may be used in end-user devices implementing the various embodiments.

FIG. 2 is a component block diagram illustrating example components in a distributed hybrid AI system in accordance with some embodiments.

FIG. 3A-3D are process flow diagrams illustrating methods of implementing a distributed hybrid AI system that intelligently partitions or splits processing tasks between a local AI model on the end-user device and a cloud-based AL model implemented on a cloud-based server in accordance with some embodiments.

FIG. 4 is a component block diagram illustrating an example computing device in the form of a laptop that is suitable for implementing some embodiments.

FIG. 5 is a component block diagram illustrating an example wireless communication device suitable for use with various embodiments.

FIG. 6 is a component diagram of an example server suitable for implementing some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods, and computing devices configured to implement the methods, of implementing a distributed hybrid AI system that intelligently partitions or splits processing tasks between a local AI model on the end-user device and an AI model (e.g., cloud-based AI model implemented on a cloud-based server). In some embodiments, the methods may include receiving multimodal data (e.g., text, images, audio, sensor data, etc.) from various sources, determining user intent based on information available to the processor (e.g., by analyzing the multimodal data using AI models or heuristics), generating filtered input data by performing context filtering on the multimodal data based on the determined user intent and segmenting the filtered input data into data segments corresponding to specific aspects of the user intent. These data segments may be converted into tokens representing attributes of the segments, such as features extracted from visual, audio, or textual data. The computing system may assign a priority to each token based on its relevance to the determined user intent and subsequently generate an enhanced prompt by selecting and organizing the highest-priority tokens. This enhanced prompt may be sent to a cloud-based AI model for further processing. The methods may further include receiving inference results from the cloud-based AI model, generating a final output by integrating the received inference results with locally processed data (i.e., data processed by at least one processor of the computing device), and presenting the final output to the user through an appropriate interface.

Various embodiments may improve the performance and functioning of computing systems and AI models by improving the distribution of processing tasks between local and cloud-based resources. By performing context filtering, tokenization, and prioritization on a user computing device (e.g., end-user device, etc.), the system may reduce the complexity and volume of data sent to the cloud, which may reduce latency and conserve bandwidth. The task distribution operations may allow the system to use the extensive computational resources of cloud-based AI models for complex analysis while maintaining responsiveness and reducing the computational load on the end-user device. In addition, the system may deliver highly personalized and contextually relevant outputs by integrating locally processed data (i.e., data processed by at least one processor of the computing device) with cloud-generated inference results, which may, in turn, improve the overall user experience. Additional improvements to the performance and functioning of the computing systems and AI models will be evident from the disclosures below.

The terms “end-user device” and “computing device” may be used interchangeably herein, and refer to (but not limited to) any one or all of personal computing devices, personal computers, workstations, laptop computers, Netbooks, Ultrabook, tablet computers, mobile communication devices, smartphones, user equipment (UE), personal data assistants (PDAs), palm-top computers, wireless electronic mail receivers, multimedia internet-enabled cellular telephones, media and entertainment systems, gaming systems (e.g., PlayStation™, Xbox™, Nintendo switch™), media players (e.g., digital versatile disc (DVD) players, Roku™, apple TV™), digital video recorders (DVRs), portable projectors, 3D holographic displays, wearable devices (e.g., earbuds, smartwatches, fitness trackers, augmented reality (AR) glasses, head-mounted displays, etc.), vehicle systems such as drones, automobiles, motorcycles, connected vehicles, electric vehicles, automotive displays, advanced driver-assistance systems (ADAS), etc., cameras (e.g., surveillance cameras, embedded cameras), smart devices (e.g., smart light bulbs, smartwatches, thermostats, smart glasses, etc.), Internet of Things (IOT) devices, other similar devices that include a programmable processing system that may be configured to provide the functionality of various embodiments.

The term “processing system” is used herein to refer to one or more processors, including multi-core processors, organized and configured to perform various computing functions within a computing device. A processing system may execute software applications or processes to allow the computing device to carry out specific tasks. Various embodiment methods may be implemented in one or more of multiple processors within a processing system, as described herein.

The term “system on chip” (SoC) is used herein to refer to a single integrated circuit (IC) chip that contains multiple resources or independent processors integrated on a single substrate. A single SoC may contain circuitry for digital, analog, mixed-signal, and radio-frequency functions. A single SoC may include a processing system that includes any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. An SoC processing system may also include software for controlling integrated resources and processors, as well as for controlling peripheral devices.

The term “system in a package” (SIP) is used herein to refer to a single module or package that contains multiple resources, computational units, cores, or processors on two or more IC chips, substrates, or SoCs. For example, a SIP may include a single substrate on which multiple IC chips or semiconductor dies are stacked vertically. Similarly, the SIP may include one or more multi-chip modules (MCMs) on which multiple ICs or semiconductor dies are packaged into a unifying substrate. An SIP may also include multiple independent SOCs coupled together via high-speed communication circuitry and packaged in close proximity, such as on a single motherboard, in a single UE, or in a single CPU device. The proximity of the SoCs facilitates high-speed communications and the sharing of memory and resources.

The term “artificial intelligence model” is used herein to refer to various information structures used by a computing device to perform computations or assess specific conditions, features, factors, datasets, or behaviors. Examples of artificial intelligence algorithms include, but are not limited to, network models, neural network models, inference models, neuron models, classifiers, random forest models, spiking neural network (SNN) models, convolutional neural network (CNN) models, recurrent neural network (RNN) models, deep neural network (DNN) models, generative network models, ensemble networks, generative adversarial networks (GANs), and genetic algorithm models. In some embodiments, an artificial intelligence model may include an architectural definition (e.g., the neural network architecture) along with one or more sets of weights (e.g., neural network weights).

The term “neural network” is used herein to refer to an interconnected group of processing nodes (or neuron models) that collectively operate as a software application or process that controls a function of a computing device and/or generates an overall inference result as output. Individual nodes in a neural network may attempt to emulate biological neurons by receiving input data, performing simple operations on the input data to generate output data, and passing the output data (also called “activation”) to the next node in the network. Each node may be associated with a weight value that defines or governs the relationship between input data and output data. A neural network may learn to perform new tasks over time by adjusting these weight values. In some cases, the overall structure of the neural network and/or the operations of the processing nodes do not change as the neural network learns a task. Rather, learning is accomplished during a “training” process in which the values of the weights in each layer are determined. As an example, the training process may include causing the neural network to process a task for which an expected/desired output is known, comparing the activations generated by the neural network to the expected/desired output, and determining the values of the weights in each layer based on the comparison results. After the training process is complete, the neural network may begin “inference” to process a new task with the determined weights.

The term “inference” is used herein to refer to a process that is performed at runtime or during the execution of the software application program corresponding to the neural network. Inference may include traversing the processing nodes in the neural network along a forward path to produce one or more values as an overall activation or overall “inference result.”

Deep neural networks implement a layered architecture in which the activation of a first layer of nodes becomes an input to a second layer of nodes, the activation of a second layer of nodes becomes an input to a third layer of nodes, and so on. As such, computations in a deep neural network may be distributed over a population of processing nodes that make up a computational chain. Deep neural networks may also include activation functions and sub-functions (e.g., a rectified linear unit that cuts off activations below zero, etc.) between the layers. The first layer of nodes of a deep neural network may be referred to as an input layer. The final layer of nodes may be referred to as an output layer. The layers in between the input and final layer may be referred to as intermediate layers, hidden layers, or black-box layers.

Each layer in a neural network may have multiple inputs and, thus, multiple previous or preceding layers. Said another way, multiple layers may feed into a single layer. For ease of reference, some of the various embodiments are described with reference to a single input or single preceding layer. However, it should be understood that the operations disclosed and described in this application may be applied to each of multiple inputs to a layer and multiple preceding layers.

The term “convolutional neural network” (CNN) may be used herein to refer to a deep neural network in which the computation in at least one layer is structured as a convolution. A convolutional neural network may also include multiple convolution-based layers, which allows the neural network to employ a very deep hierarchy of layers. In convolutional neural networks, the weighted sum for each output activation is computed based on a batch of inputs, and the same matrices of weights (called “filters”) are applied to every output. These networks may also implement a fixed feedforward structure in which all the processing nodes that make up a computational chain are used to process every task, regardless of the inputs. In such feed-forward neural networks, all of the computations are performed as a sequence of operations on the outputs of a previous layer. The final set of operations may generate the overall inference result of the neural network, such as a probability that an image contains a specific object (e.g., a person, cat, watch, edge, etc.) or information indicating that a proposed action should be taken.

The term “recurrent neural network” (RNN) is used herein to refer to a class of neural networks that are particularly well-suited for sequence data processing. Unlike feedforward neural networks, RNNs may include cycles or loops within the network that allow information to persist. This allows RNNs to maintain a “memory” of previous inputs in the sequence, which may be beneficial for tasks in which temporal dynamics and the context in which data appears are relevant.

The term “long short-term memory network” (LSTM) may be used herein to refer to a specific type of RNN that addresses some of the limitations of basic RNNs, particularly the vanishing gradient problem. LSTMs include a more complex recurrent unit that allows for the easier flow of gradients during backpropagation. This facilitates the model's ability to learn from long sequences and remember over extended periods.

The term “transformer” may be used herein to refer to a specific type of neural network that includes an encoder and/or a decoder and is particularly well-suited for sequence data processing. Transformers may use multiple self-attention components to process input data in parallel rather than sequentially. The self-attention components may be configured to weigh different parts of an input sequence when producing an output sequence. Unlike solutions that focus on the relationship between elements in two different sequences, self-attention components may operate on a single input sequence. The self-attention components may compute a weighted sum of all positions in the input sequence for each position, which may allow the model to consider other parts of the sequence when encoding each element. This may offer advantages in tasks that benefit from understanding the contextual relationships between elements in a sequence. The weights may be learned during the training phase, allowing the model to focus on the most contextually relevant parts of the input for the task at hand. Transformers, with their specialized architecture for handling sequence data and their capacity for parallel computation, often serve as foundational elements in constructing large generative AI models (LXM).

The term “large generative AI model” (LXM) may be used herein to refer to an advanced computational framework that includes any of a variety of specialized AI models including, but not limited to, large language models (LLMs), large speech models (LSMs), large/language vision models (LVMs), vision language models (VLMs)), hybrid models, and multi-modal models. An LXM may include multiple layers of neural networks (e.g., RNN, LSTM, transformer, etc.) with millions or billions of parameters. Unlike traditional systems that translate user prompts into a series of correlated files or web pages for navigation, LXMs support dialogic interactions and encapsulate expansive knowledge in an internal structure. As a result, LXMs are capable of providing direct answers and/or are otherwise adept at various tasks, such as text summarization, translation, complex question-answering, conversational agents, etc. In various embodiments, LXMs may operate independently as standalone units, may be integrated into more comprehensive systems and/or into other computational units (e.g., those found in a SoC or SIP, etc.), and/or may interface with specialized hardware accelerators to improve performance metrics such as latency and throughput.

The term “feature space” may be used herein to refer to a multi-dimensional information structure in which each dimension represents a specific feature or attribute of the data being analyzed. Each data point (e.g., object, event, observation, etc.) may be represented as a vector in the multi-dimensional space/structure. The dimensions of the feature space may correspond to the features of the dataset, which may include various properties or characteristics of the data points.

The term “embedding layer” may be used herein to refer to a specialized layer within a neural network, typically at the input stage, that transforms continuous or discrete categorical values or tokens into feature spaces or continuous, high-dimensional vectors. An embedding layer may also transform high-dimensional data into low-dimensional vectors (e.g., using “dimensionality reduction” techniques, etc.), which may be particularly useful when the original data is complex or too large to handle efficiently. In some embodiments, the embedding layer may convert tokens (typically low-dimensional entities) into high-dimensional vectors or feature spaces. An embedding layer may operate as a lookup table in which each unique token or category is mapped to a point in a continuous vector space. The vectors may be refined during the model's training phase to encapsulate the characteristics or attributes of the tokens in a manner that is conducive to the tasks the model is configured to perform.

The term “token” may be used herein to refer to a unit of information that an LXM may read as a single input during training and inference. Each token may represent any of a variety of different data types. For example, in text-centric models such as in LLMs, each token may represent one or more textual elements such as a paragraph(s), sentence(s), clause(s), word(s), sub-word(s), character(s), etc. In models designed for auditory data, such as LSMs, each token may represent a feature extracted from audio signals, such as a phoneme, spectrogram, temporal dependency, Mel-frequency cepstral coefficients (MFCCs) that represent small segments of an audio waveform, etc. In visual models such as LVM, each token may correspond to a portion of an image (e.g., pixel blocks), sequences of video frames, etc. In hybrid systems that combine multiple modalities (text, speech, vision, etc.), each token may be a complex data structure that encapsulates information from various sources. For example, a token may include both textual and visual information, each of which independently contributes to the token's overall representation in the model.

Each token may be converted into a numerical vector via the embedding layer. Each vector component (e.g., numerical value, parameter, etc.) may encode an attribute, quality, or characteristic of the original token. The vector components may be adjustable parameters that are iteratively refined during the model training phase to improve the model's performance during subsequent operational phases. The numerical vectors may be high-dimensional space vectors (e.g., containing more than 300 dimensions, etc.) in which each dimension in the vector captures a unique attribute, quality, or characteristic of the token. For example, dimension 1 of the numerical vector may encode the frequency of a word's occurrence in a corpus of data; dimension 2 may represent the pitch or intensity of the sound of the word at its utterance; dimension 3 may represent the sentiment value of the word, etc. Such intricate representation in high-dimensional space may help the LXM understand the semantic and syntactic subtleties of its inputs. During the operational phase, the tokens may be processed sequentially through layers of the LXM or neural network, which may include structures or networks appropriate for sequence data processing, such as transformer architectures, recurrent neural networks (RNNs), or long short-term memory networks (LSTMs).

The term “sequence data processing” may be used herein to refer to techniques or technologies for handling ordered sets of tokens in a manner that preserves their original sequential relationships and captures dependencies between various elements within the sequence. The resulting output may be a probabilistic distribution or a set of probability values, each corresponding to a “possible succeeding token” in the existing sequence. For example, in text completion tasks, the LXM may suggest the possible succeeding token determined to have the highest probability of completing the text sequence. For text generation tasks, the LXM may choose the token with the highest determined probability value to augment the existing sequence.

The term “enhanced prompt” is used herein to refer to a prompt suitable for submission to a local or remote AI model (e.g., LXM, etc.) that is generated based on an initial prompt (e.g., user prompt, etc.), contextual information, user profile information, or other relevant information that is input into or collected by the end-user device. An enhanced prompt may include information that has been filtered, pruned, segmented, updated, and/or augmented. For example, an enhanced prompt may include a filtered or refined subset of the information associated with an initial prompt.

The term “bitmap” is used herein to refer to a data structure, representation, or mapping that assigns bits of information to items within a dataset. A bitmap may represent the importance, relevance, or priority of data elements (e.g., tokens, segments, etc.) in the dataset. A bitmap may be used to prioritize portions of data for transmission, processing, or further analysis based on factors such as user intent, contextual relevance, or computational constraints.

The term “hard bitmap” is used herein to refer to a bitmap that explicitly specifies which data elements or tokens are to be transmitted or processed. A hard bitmap may function as a binary map in which each bit or value designates whether a specific data element should be included in the next stage of processing or transmission.

The term “soft bitmap” is used herein to refer to a bitmap that assigns probabilities or weighted values to data elements or tokens (as opposed to making a binary inclusion/exclusion decision). A soft bitmap may allow for a more flexible approach to data selection in which elements with higher probabilities or weights are more likely to be transmitted or processed. Lower-priority elements could still be considered based on the available resources or specific conditions.

The terms “user intent,” “user focus,” and “user priority” may be used interchangeably herein and refer to an information structure (e.g., vector, etc.) that characterizes the specific goals, preferences, or objectives that a user aims to achieve when interacting with a computing system or AI model. These information structures may include diverse types of data derived from various input sources, such as verbal commands, textual queries, visual cues, gestures, or other interaction types. Some embodiments may include a computing system configured to determine and refine these goals locally on the device. This may enhance the customization and relevance of the output generated by the AI model and/or improve the quality of the responses generated by cloud-based solutions.

The term “multimodal” is used herein to refer to data or an information structure that includes or integrates different modalities or different types of data received or collected by a computing system. Multimodal data may include text, audio, images, video, sensor data, etc. Multimodal data may be collected from a variety of sensory inputs, such as auditory signals, visual cues, motion-related metrics, geographical indicators, physiological measures, neurophysiological inputs, and tactile feedback. Multimodal data may also be collected from diverse data sources, including but not limited to microphones, cameras, inertial measurement units (IMU) and Global Positioning System (GPS) receivers, keyboards, touchscreens, brain-computer interfaces, controllers, eye trackers, haptic sensors, heart rate monitors, etc. In some embodiments, the computing system may be configured to process and categorize this raw input data into specific types such as audio data, image/video streams, locational coordinates, motion data, textual data, electroencephalograph (EEG) data, heart rate metrics, and gaze information. These data sources may provide complementary insights that allow the computing system to analyze and interpret complex interactions more effectively.

The term “user profile information” is used herein to refer to data or an information structure (e.g., vector, record, etc.) that characterizes or represents the preferences, behaviors, and attributes of a specific user. The user profile information may include data points such as demographic details, interaction history, content preferences, language preferences, device usage patterns, and other personalized information. The computing system may use the user profile information to determine the user intent and tailor its responses, recommendations, or interactions so that they are more aligned with the intentions and preferences of an individual user.

The term “context information” is used herein to refer to an information structure (e.g., vector, etc.) that characterizes or represents the circumstances, conditions, or environment surrounding a user interaction. Context information may include attributes such as the user's current location, time of day, device status, network conditions, user activity level, and environmental factors (e.g., lighting, noise levels, etc.).

The term “attention-based metrics” (ABM) is used herein to refer to data units or information structures that quantify, measure, or otherwise characterize various facets of user attention, user engagement, user focal point, user area of interest, etc. ABMs may be derived based on various techniques, factors, conditions and/or data sources, including, but not limited to, eye gaze tracking or focus levels measured through eye-tracking technologies, mouse cursor positioning, mouse movements, time on task (e.g., time spent on specific tasks), touch input, keyboard activity, scroll behavior, page focus events, application usage, audio cues, facial recognition, biometric data, device sensors, environmental sensors, proximity sensors, machine learning algorithms, real-time user behavior, ongoing workflow, prevailing interests, historical data, user profiles, task complexity, user feedback, calendar data, sentiment analysis, browser tabs, system notifications, anomaly detection, multi-device behavior, social interactions, etc. ABMs may be used in real time or may be aggregated over time to provide a longitudinal view of user behavior and focus. In some embodiments, the ABMs may serve to inform and adapt the functionality of other systems, such as LXMs, SoCs, etc. The ABMs may be generated and analyzed by a single computational unit within a processing system or may result from collaborative computations across multiple independent processing systems. The ABMs may be stored in on-board memory blocks or off-site data storage solutions, subjected to further analysis to refine their accuracy or utility, and/or incorporated into adaptive algorithms to improve system performance, improve the user experience, guide the operation of specialized hardware or software components, etc.

The term “attention tracking” is used herein to refer to operations performed by at least one processor in the processing system of a computing device for monitoring and recording various attention-based metrics (ABMs) that quantify and characterize user interaction and focus dimensions, such as user attention, engagement, focal points, and/or areas of interest within a digital environment. In some embodiments, at least one processor in the processing system may be configured to implement and utilize attention-tracking techniques and technologies to collect, generate, and/or analyze ABMs in real-time or near-real-time. At least one processor in the processing system may use these ABMs or the analysis results to dynamically adjust and refine the output of LXMs to better align with the user's immediate needs, preferences, or current focus. In some embodiments, attention-tracking functionality may be integrated into at least one processor in the processing system as embedded hardware or software components, function as separate peripheral units, or be managed by multiple processing systems that collaborate to improve the system's response and interaction with the user.

The term “threshold” is used herein to refer to a dynamically adjustable value or criterion used to determine the selection, inclusion, exclusion, or prioritization of data elements, such as tokens, within a processing system. The threshold may operate as a filter, setting the minimum requirement or condition that data must meet to be processed, transmitted, or further analyzed. In various embodiments, the threshold may be based on factors such as network bandwidth, computational resources, user intent, or contextual relevance. The threshold may be continuously monitored and updated in real-time to improve the system's performance and so that only the most relevant data is selected or prioritized for subsequent processing stages.

Some embodiments discussed herein include components and processing systems configured to compress data or perform any of a variety of compression techniques. Examples of compression techniques that could be used to implement the various embodiments include lossless compression algorithms (e.g., Huffman coding, Lempel-Ziv-Welch (LZW), run-length encoding (RLE), etc.) that preserve the original data without any loss of information. Other embodiments may use lossy compression techniques, such as Joint Photographic Experts Group (JPEG) or Moving Picture Experts Group (MPEG) for images and video, which reduce data size by approximating the original data with some acceptable loss of quality. In some embodiments, the systems may be configured to dynamically select the appropriate compression method based on factors such as network conditions, data types, and user requirements. Hybrid techniques that combine lossless and lossy methods may also be used to improve performance for specific data types, such as multimodal content involving text, audio, and visual elements. The compression techniques described are not mutually exclusive, limiting, or required unless explicitly stated in the claims. The specific compressing techniques and technologies disclosed and described in this application should not be interpreted as being limiting or required unless expressly recited as such in the claims.

The rapid growth of cellular and wireless communication technologies has been driven by improvements in hardware, expanded networks, and more reliable communication protocols. Wireless service providers now offer a wide range of features and services, giving users unprecedented access to information and communication resources. To support these advanced services, end-user devices such as smartphones and wearables have become increasingly powerful and complex, incorporating system-on-chips (SoCs), multiple microprocessor cores, neural processing units (NPUs), artificial intelligence (AI) processors, and multimodal sensors with auditory, visual, and inertial measurement capabilities.

Concurrent advancements in artificial intelligence (AI) and machine learning (ML) have produced highly capable AI models, particularly in natural language processing, computer vision, and auditory data interpretation. Multimodal sensors in end-user devices may collect or generate data that enhances interactions with these AI models. For example, modern sensors may capture real-time indicators such as emotional states, facial expressions, and attentiveness levels.

Due to their high computational and resource demands, AI models are often deployed in cloud environments that offer extensive processing power and storage capacity. While this centralized approach may support large-scale data processing, it may also present several technical challenges, such as high communication and inference costs, latency, dependency on network conditions, and generic all-purpose models.

Recent advancements in hardware, such as the inclusion of AI processors in mobile and IoT devices, have opened new possibilities for distributing AI workloads between local and cloud-based systems. The integration of AI processors into end-user devices may allow for the creation of hybrid or distributed generative AI solutions that allow certain AI tasks to be performed locally using general, specialized, or fine-tuned AI models. While such local processing may reduce overall costs and improve system efficiency and response times, several technical challenges may limit the effectiveness of such solutions.

Designing an effective hybrid AI system that efficiently partitions or splits the workload between the local device and the cloud remains a challenge. Most conventional AI models are monolithic and designed to operate entirely in the cloud, leading to high communication costs, latency issues, and inefficient use of network resources, particularly when transmitting large volumes of unfiltered multimodal data. In addition, processing entire unfiltered data in the cloud may lead to suboptimal results because the cloud-based system may not be able to adequately focus on the most relevant portions of the input data. Simply dividing a monolithic model for local and cloud deployment may result in inefficiencies and reduced performance, as these models were not originally designed or configured for distributed processing.

Various embodiments include computing systems (end-user devices, etc.), processing systems, and/or components configured to implement a distributed hybrid AI system that intelligently partitions or splits processing tasks between a local generative AI model (e.g., local LXM, etc.) on the end-user device and a cloud-based generative AI model (e.g., cloud-based LXM, etc.) implemented on one or more cloud-based servers. The end-user device may include a processing system that includes at least one processor that analyzes and processes multimodal user prompts, user profile information, and context information to generate tokens, uses sophisticated filtering mechanisms to filter the generated tokens locally on the device, and sends the filtered tokens or data derived from the filtered tokens to a cloud-based LXM for further analysis. By performing preliminary tasks such as intent classification, context filtering, and data segmentation locally on the device, the end-user device may reduce the reliance on cloud resources, decrease the amount of data transmitted to the cloud, improve response times, lower communication and computation costs, allow the cloud-based LXM to focus its operations and resources on performing complex inference tasks, and improve the overall performance and accuracy of AI-driven interactions.

In some embodiments, at least one processor in the processing system may be configured to perform local processing of multimodal data, which may include, but is not limited to, visual data (e.g., images, video frames, etc.), auditory data (e.g., audio signals, etc.), sensor data (e.g., accelerometer readings, temperature, humidity, etc.), and textual data (e.g., user prompts, commands, etc.). At least one processor in the processing system may analyze the multimodal data to determine the user's intent, focus, or priority (e.g., by interpreting emotional states, activities, gaze direction, etc.). At least one processor in the processing system may perform context-filtering operations that include segmenting and isolating the most relevant portions of the multimodal data. For example, if the multimodal data includes an image of a vehicle and the user's query pertains to identifying the make and model of a vehicle, at least one processor in the processing system may crop the image to focus on the vehicle and exclude irrelevant background details. At least one processor in the processing system may evaluate this cropped image segment locally or send it to the cloud-based LXM for further analysis.

In some embodiments, at least one processor in the processing system may tokenize the input data to convert it into numerical vectors or feature spaces that represent specific attributes or characteristics of the original multimodal data. At least one processor in the processing system may score or assign weights to these tokens based on their relevance to the determined user intent, focus, or priority. For example, higher scores may indicate greater importance. At least one processor in the processing system may maintain and adjust a threshold for sending the filtered data to the cloud. Adjusting the threshold value may be particularly important in scenarios in which network bandwidth is limited, communication costs are high, or other similar constraints exist.

In some embodiments, the local end-user device and the cloud-based servers may include the same or similar tokenizer components, and at least one processor in the processing system may send the filtered tokens directly to the cloud-based LXM. In some embodiments, at least one processor in the processing system may convert the tokens into a format that is supported by the cloud-based LXM (e.g., text, etc.). In some embodiments, at least one processor in the processing system may apply the tokenized data to a local AI model to generate local inference results, generate an enhanced prompt based on the locally generated inference results, and send the enhanced prompt to a local or cloud-based LXM. In some embodiments, at least one processor in the processing system may be configured to crop relevant sections (for visual or non-textual data) and transmit the cropped sections (with or without tokenization). For example, the system may crop an image to highlight the area of interest and compress the cropped image before transmission to reduce data size and improve resource usage. In some embodiments, at least one processor in the processing system may determine whether to send filtered data, compressed data, or a combination thereof. In some cases, tokenization may not be necessary or desirable, such as when processing raw sensor data from devices like accelerometers or GPS sensors that provide continuous streams of numerical values without explicit semantic meaning. In these scenarios, the system may directly transmit these signals to the cloud-based LXM for further analysis, bypassing the tokenization process to preserve the integrity of the data and streamline the processing workflow.

In some embodiments, at least one processor in the processing system may be configured to perform bitmap-based selection operations that include generating a bitmap that maps the importance or relevance of different data elements (e.g., tokens, segments, etc.) within the dataset. The bitmap may be a hard bitmap that indicates a binary inclusion/exclusion of data elements or a soft bitmap that assigns probabilities or weighted values to elements for a more nuanced data selection process. The bitmap-based selection operations may allow at least one processor in the processing system to select and prioritize the most relevant portions of the multimodal data for transmission while still allowing for flexible adjustments based on available resources and changing conditions.

In some embodiments, at least one processor in the processing system may be configured to implement a combination of communication strategies (e.g., sending tokens directly, bitmap-based selection, compression, etc.) so that the most relevant information is transmitted to the cloud-based LXM. At least one processor in the processing system may dynamically adjust the communication strategy based on real-time factors such as network bandwidth, latency, computational load, and user-specific constraints or preferences. For example, at least one processor in the processing system may prioritize sending only the most important data elements during periods of high network congestion and/or send additional context or higher-resolution data during periods of low congestion.

The cloud-based LXM may process the segmented, filtered, and/or refined data received from the end-user device to generate more accurate and contextually relevant responses. By focusing on the most important data segments, the cloud-based LXM may allocate its computational resources more effectively to improve inference accuracy and response times. In some embodiments, the cloud-based LXM may also incorporate feedback or additional data received from at least one processor in the processing system to refine its operations.

In some embodiments, the local end-user device may be configured to store, access, or use user profile information, which may include data such as user preferences, interaction history, and personalized settings. In some embodiments, the local end-user device may be configured to store, access, or use context information, which may include the current location of the device, device status, environmental conditions, and other relevant parameters. At least one processor in the processing system may use the user profile information and/or context information to determine and further refine the user intent and to customize the responses generated by the AI models.

In some embodiments, the local end-user device may be configured to store, access, or use attention-based metrics (ABMs) to monitor and record various aspects of user interaction, such as engagement levels, focal points, and areas of interest. At least one processor in the processing system may use these ABMs to determine user intent based on information available to the processor or to adjust its operations dynamically in real-time. For example, at least one processor in the processing system may dynamically adjust the data transmission strategies by modifying the bitmap thresholds or selecting different data segments for processing based on the ABMs.

In some embodiments, at least one processor in the processing system in the local end-user device may be configured to receive and use multimodal data to perform context filtering, data segmentation, data tokenization, token prioritization, and adaptive data transmission operations to invoke cloud-based processing of data or a prompt generated based on the multimodal data or a filtered subset of the received multimodal data. At least one processor in the processing system may receive and use the results of the cloud-based processing to perform post-processing and response generation operations to generate a final output. The local end-user device may present the final output to the user in a suitable format (e.g., display information on an electronic display screen, provide audio feedback, perform a responsive action, etc.).

In some embodiments, at least one processor in at least one processor in the processing system may be configured to collect multimodal data from various sources, including visual data (e.g., images, video frames), auditory data (e.g., audio signals), sensor data (e.g., accelerometer readings, GPS data), and textual data (e.g., user prompts, commands). At least one processor in the processing system may perform preliminary preprocessing of the input data to remove noise, normalize formats, and prepare the data for further analysis. At least one processor in the processing system may analyze the input data to determine the user's intent, focus, or priority (e.g., by evaluating factors such as emotional state, activity level, gaze direction, contextual environment, etc.).

In some embodiments, at least one processor in the processing system may be configured to perform multimodal or cross-modal relationship identification operations that include analyzing the multimodal data to identify relationships between different data modalities. For example, the computing device may correlate verbal prompts captured by a microphone with visual data from a camera and determine whether the user's spoken instructions or questions are directed toward specific objects or regions within an image or video. At least one processor in the processing system may synchronize audio cues with corresponding visual events, such as by matching a user's command, like “zoom in on the car,” with the location of the car in the visual input. At least one processor in the processing system may analyze facial expressions or gestures detected by the camera and associate them with relevant portions of audio or text inputs to better identify and understand the user intent. At least one processor in the processing system may filter the input based on the identified relationships or the results of the analysis operations to include the most relevant sections (e.g., a particular subject in the image, a key portion of an audio recording, etc.). This cross-modal analysis may help the system provide more nuanced and accurate responses, particularly in complex scenarios involving multiple types of input data.

In some embodiments, at least one processor in the processing system may be configured to determine user intent based on information available to the processor by analyzing multimodal data (e.g., text, audio, visual, and sensor information) collected by the local device or input by the user and filter data based on the determined user intent. For example, when processing an image with a user query like “What is the person in the image doing?” at least one processor in the processing system may identify the relevant portion of the image, crop it to include the person, and send only the cropped section to the cloud for further analysis. Similarly, if a user asks, “What is the model of the car in the image?” the system may identify the car, crop the relevant section, and send it to the cloud.

In some embodiments, at least one processor in the processing system may be configured to determine the user intent based on the information available to the processor by deriving the user intent from sensory data obtained from one or more input devices. For example, at least one processor in the processing system may derive the user intent from gaze detection data obtained from augmented reality (AR) glasses worn by the user.

In some embodiments, at least one processor in the processing system may be configured to filter the input data based on the determined user intent, isolate the most relevant portions, and segment the filtered data into smaller, more manageable portions that are directly relevant to the determined user intent. For example, at least one processor in the processing system may filter the input data by cropping images to focus on specific objects (e.g., a vehicle in a photo, etc.) and segment the filtered data by creating or generating bounding boxes around those objects.

In some embodiments, the context filtering operations may include discarding irrelevant data or noise so that only the most relevant information is transmitted to the cloud for further analysis. For example, at least one processor in the processing system may filter out background elements in a video and focus solely on the frames that illustrate a person's movements in response to receiving a user query about that specific person's actions.

In some embodiments, at least one processor in the processing system may be configured to perform context-filtering operations that include isolating and segmenting portions of the input data that are most relevant to the determined user intent. For example, when processing an image with a user query or prompt like “What is the person in the image doing?” the local device may focus on identifying a person within the image, crop the relevant portion of the image to include the identified person, and send only the cropped section to the cloud for detailed analysis. As another example, when a user queries the system with a prompt like “What is the model of the car in the image?” at least one processor in the processing system may analyze the image locally to identify the car, crop the relevant section, and send only this focused portion to the cloud. This may reduce the amount of data that is transmitted over the network and allow the cloud-based AI system to focus its operations on inference or tasks that are more computationally intensive or high-value.

In some embodiments, at least one processor in the processing system may be configured to convert the segmented data into tokens that represent specific attributes or characteristics of the original multimodal data. At least one processor in the processing system may evaluate and score each token based on its relevance to the determined user intent (e.g., higher scores may indicate greater importance, etc.). At least one processor in the processing system may generate a bitmap to represent the importance of each token. At least one processor in the processing system may generate a hard bitmap that uses binary values (0 or 1) or a soft bitmap that uses a range of values to indicate the relative importance of each token.

In some embodiments, at least one processor in the processing system may be configured to convert multimodal data (e.g., text, images, audio) into tokens, apply filtering techniques to prioritize tokens based on relevance, and send the filtered tokens to a cloud-based server. In some embodiments, at least one processor in the processing system may be configured to generate bitmaps that indicate the importance of tokens and send only the most relevant tokens to the cloud. In some embodiments, at least one processor in the processing system may adjust its data transmission strategies based on real-time network conditions. In some embodiments, at least one processor in the processing system may be configured to repeatedly or continuously update user context information and dynamically adjust operations so that the AI responses align with the user's current context and intent.

In some embodiments, at least one processor in the processing system may be configured to dynamically adjust the threshold for token transmission based on real-time factors such as network bandwidth, computational resources, and communication costs. At least one processor in the processing system may select the most important data segments or tokens for transmission based on the adjusted thresholds and/or the generated bitmap.

In some embodiments, at least one processor in the processing system may be configured to compress selected data segments or tokens to reduce data size (e.g., in response to determining that a large volume of context data should be transmitted to the cloud-based LXM, in response to detecting a low-bandwidth situation, etc.).

In some embodiments, at least one processor in the processing system may be configured to improve data transmissions by isolating and segmenting important data segments before sending them to the cloud-based LXM. In some embodiments, these operations may include compressing select portions of an image while retaining relevant context so that only the most relevant information is processed by the cloud-based LXM.

In some embodiments, at least one processor in the processing system may be configured to send the selected (and compressed) data segments or tokens to a cloud-based LXM for further processing. The cloud-based LXM may use the received data to perform inference operations and generate inference results that include more accurate and/or relevant information. The inference results may be sent back to the local processing system for further refinement or direct presentation to the user.

At least one processor in the processing system may receive and use the inference results from the cloud-based LXM to generate and present a final output to the user. In some embodiments, at least one processor in the processing system may be configured to integrate cloud-based inference results with data processed by the at least one processor (referred to herein as locally processed data) to generate responses tailored to the user's original input and context. In some embodiments, these operations may include tailoring the final output based on environmental conditions or device attributes. The final output may include answers, recommendations, or other responses tailored to the user based on the determined user intent, context information, user profile information, etc.

In some embodiments, at least one processor in the processing system may be configured to monitor the user's interaction with the system to collect attention-based metrics (ABMs) and other feedback data. At least one processor in the processing system may update the user's profile and context information based on the monitored interaction and feedback. At least one processor in the processing system may adjust its operations (e.g., token prioritization and data transmission methods, etc.) based on the monitored interaction and feedback or updated user profile, context information, ABMs, etc.

In some embodiments, at least one processor in the processing system may be configured to receive multimodal data from at least one input source, analyze the multimodal data to determine user intent based on information available to the processor, filter and segment the multimodal data based on the determined user intent, tokenize the filtered and segmented input data into data tokens (e.g., convert the data segments into tokens representing attributes of the data segments), generate a bitmap indicating the importance of each data token, use the generated bitmap to select data tokens and metadata for transmission to a cloud-based generative AI model, receive a response from the cloud-based generative AI model, generate a final output based on a result of analyzing the information included in the received response in conjunction with local context information, and present the final output to a user.

In some embodiments, analyzing multimodal data may include analyzing at least two or more types of data, such as audio data, video data, and text data. In some embodiments, analyzing the multimodal data may include determining the relationship between different modalities of the multimodal data.

In some embodiments, filtering and segmenting the multimodal data may include extracting portions of the multimodal data that are most relevant to user intent and compressing additional context to preserve relevant information. In some embodiments, filtering and segmenting the multimodal data may include generating metadata that includes bounding box coordinates for visual data, segmentation polygons for visual data, frame index of video visual data, camera index of multi-camera visual data, start/stop timestamps for audio data, and text subsections for text data. In some embodiments, the metadata may also include object detection confidence scores, semantic labels assigned to detected objects within the image, spatial and temporal relationships between detected objects or events, gaze and attention metrics indicating user focus within visual content, environmental context such as lighting conditions or background noise levels, user interaction history with similar content, sensor data annotations providing additional context or correlations across modalities, sentiment analysis results reflecting the emotional tone in textual or auditory data, quality metrics such as signal-to-noise ratio or image resolution, and other details such as device identifiers, timestamps, and data source reliability.

In some embodiments, tokenizing the filtered and segmented input data into the data tokens may include tokenizing the filtered and segmented input data into text tokens, visual tokens, or audio tokens. In some embodiments, tokenizing the filtered and segmented input data into data tokens may include converting the filtered and segmented input data into a structured format compatible with the cloud-based generative AI model.

In some embodiments, generating the bitmap indicating the importance of each data token may include using a hard bitmap to directly specify which tokens to transmit to the cloud-based generative AI model, using a soft bitmap to assign probabilities to tokens, and sampling from the soft bitmap to determine the tokens to send based on a predefined communication or computational budget.

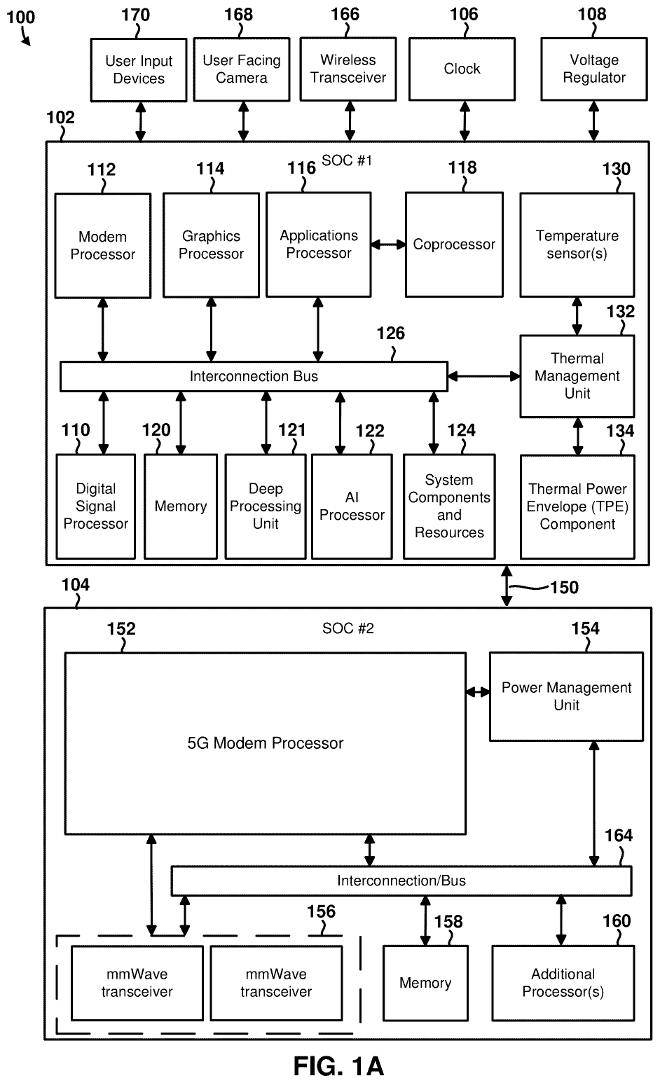

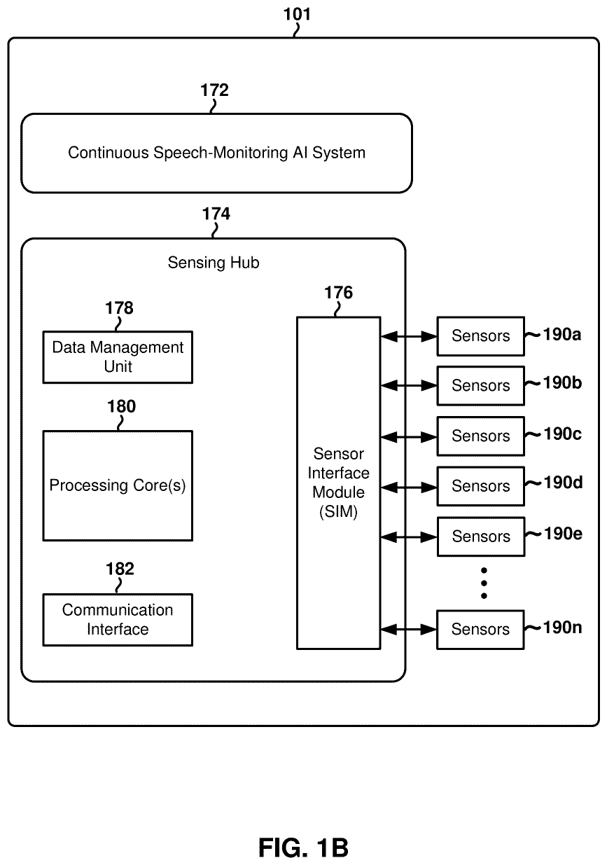

Various embodiments may be implemented on a variety of single-processor and multiprocessor computer systems, including a system-on-chip (SOC) or system in a package (SIP). FIG. 1A illustrates an example computing system or SIP 100 architecture that may be used in end-user devices implementing the various embodiments.

With reference to FIG. 1A, the illustrated example SIP 100 includes two SOCs 102, 104, a clock 106, a voltage regulator 108, a wireless transceiver 166, a user-facing camera 168, and user input devices 170 (e.g., a touch-sensitive display, a touchpad, a mouse, etc.). The first and second SOC 102, 104 may communicate via interconnection bus 150. Various processors 110, 112, 114, 116, 118, 121, 122, may be interconnected to each other and to one or more memory elements 120, system components and resources 124, and a thermal management unit 132 via an interconnection bus 126, which may include advanced interconnects such as high-performance networks-on-chip (NOCs). Similarly, the processor 152 may be interconnected to the power management unit 154, the mmWave transceivers 156, memory 158, and various additional processors 160 via the interconnection bus 164. These interconnection buses 126, 150, 164 may include an array of reconfigurable logic gates and/or implement a bus architecture (e.g., CoreConnect, AMBA, etc.). Communications may be provided by advanced interconnects, such as NOCs.

In various embodiments, any, or all of the processors 110, 112, 114, 116, 121, 122, in the system may operate as the SoC's main processor, central processing unit (CPU), microprocessor unit (MPU), arithmetic logic unit (ALU), etc. One or more of the coprocessors 118 may operate as the CPU.

In some embodiments, the first SOC 102 may operate as the central processing unit (CPU) of the mobile computing device that carries out the instructions of software application programs by performing the arithmetic, logical, control and input/output (I/O) operations specified by the instructions. In some embodiments, the second SOC 104 may operate as a specialized processing unit. For example, the second SOC 104 may operate as a specialized 5G processing unit responsible for managing high volume, high speed (e.g., 5 Gbps, etc.), and/or very high-frequency short wavelength (e.g., 28 GHz mmWave spectrum, etc.) communications.

The first SOC 102 may include a digital signal processor (DSP) 110, a modem processor 112, a graphics processor 114, an application processor 116, one or more coprocessors 118 (e.g., vector co-processor, CPUCP, etc.) connected to one or more of the processors, memory 120, deep processing unit (DPU) 121, artificial intelligence processor 122, system components and resources 124, an interconnection bus 126, one or more temperature sensors 130, a thermal management unit 132, and a thermal power envelope (TPE) component 134. The second SOC 104 may include a 5G modem processor 152, a power management unit 154, an interconnection bus 164, a plurality of mmWave transceivers 156, memory 158, and various additional processors 160, such as an applications processor, packet processor, etc.

Each processor 110, 112, 114, 116, 118, 121, 122, 121, 122, 152, 160 may include one or more cores, and each processor/core may perform operations independent of the other processors/cores. For example, the first SOC 102 may include a processor that executes a first type of operating system (e.g., FreeBSD, LINUX, OS X, etc.) and a processor that executes a second type of operating system (e.g., MICROSOFT WINDOWS 11). In addition, any, or all of the processors 110, 112, 114, 116, 118, 121, 122, 121, 122, 152, 160 may be included as part of a processor cluster architecture (e.g., a synchronous processor cluster architecture, an asynchronous or heterogeneous processor cluster architecture, etc.).

Any or all of the processors 110, 112, 114, 116, 118, 121, 122, 121, 122, 152, 160 may operate as the CPU of the mobile computing device. In addition, any, or all of the processors 110, 112, 114, 116, 118, 121, 122, 121, 122, 152, 160 may be included as one or more nodes in one or more CPU clusters. A CPU cluster may be a group of interconnected nodes (e.g., processing cores, processors, SOCs, SIPs, computing devices, etc.) configured to work in a coordinated manner to perform a computing task. Each node may run its own operating system and contain its own CPU, memory, and storage. A task that is assigned to the CPU cluster may be divided into smaller tasks that are distributed across the individual nodes for processing. The nodes may work together to complete the task, with each node handling a portion of the computation. The results of each node's computation may be combined to produce a final result. CPU clusters are especially useful for tasks that can be parallelized and executed simultaneously. This allows CPU clusters to complete tasks much faster than a single, high-performance computer. Additionally, because CPU clusters are made up of multiple nodes, they are often more reliable and less prone to failure than a single high-performance component.

The first and second SOC 102, 104 may include various system components, resources, and custom circuitry for managing sensor data, analog-to-digital conversions, wireless data transmissions, and for performing other specialized operations, such as decoding data packets and processing encoded audio and video signals for rendering in a web browser. For example, the system components and resources 124 of the first SOC 102 may include power amplifiers, voltage regulators, oscillators, phase-locked loops, peripheral bridges, data controllers, memory controllers, system controllers, Access ports, timers, and other similar components used to support the processors and software clients running on a computing device. The system components and resources 124 may also include circuitry to interface with peripheral devices, such as cameras, electronic displays, wireless communication devices, external memory chips, etc.

The first and/or second SOCs 102, 104 may further include an input/output module (not illustrated) for communicating with resources external to the SOC, such as the clock 106, the voltage regulator 108, the wireless transceiver 166 (e.g., cellular wireless transceiver, Bluetooth transceiver, etc.), the user facing camera 168 and user input devices 170 (e.g., a touch-sensitive display, a touch pad, a mouse, etc.). Resources external to the SOC (e.g., clock 106, voltage regulator 108, wireless transceiver 166) may be shared by two or more of the internal SOC processors/cores. Further, the first and/or second SOCs 102, 104 may be configured with modules for processing data received from the user facing camera 168 and user input devices 170 to track a user's attention as described herein.

In addition to the example SIP 100 discussed above, various embodiments may be implemented in various computing systems, including a single processor, multiple processors, multicore processors, or any combination thereof.

FIG. 1B illustrates an example of computing system 101 architecture that may be used in end-user devices to implement various embodiments. With reference to FIG. 1B, the computing system 101 may include a continuous speech-monitoring AI system 172 that is configured to continuously or perpetually listen to and analyze spoken language and other multimodal data, convert spoken language into text via speech recognition, and identify user queries. In some embodiments, the continuous speech-monitoring AI system 172 may maintain an ongoing auditory observation of the user (e.g., continuously listening and analyzing) to better understand the user's context, emotional tone, and immediate needs. The continuous speech-monitoring AI system 172 may also implement and/or use advanced natural language processing (NLP) algorithms to interpret spoken words, phrases, or sentences for the context information or user profile information.

The computing system 101 may also include a sensing hub 174. The sensing hub 174 may be a specialized component in the computing system 101 that is dedicated to gathering multimodal data from various sensors, including auditory signals from a microphone, visual data from a camera, and biometric indicators from wearable devices. The sensing hub 174 may be configured to interface with a multitude of sensors 190a-190n through a dedicated sensor interface module (SIM) 176. Examples of such sensors 190a-190n include accelerometers for linear motion detection, gyroscopes for assessing angular velocity and positioning, temperature sensors, humidity detectors, barometers, ambient light gauges, proximity detectors, orientation trackers, infrared sensors, physical activity monitors, distance measurers, geolocation trackers, heart activity monitors, environmental detectors, biometric identifiers (e.g., fingerprints, retinal scans, and facial recognition), blood pressure and glucose monitors, alcohol detectors, and specialized sensors for applications such as acidity assessment, thermal imaging, spatial mapping, deflection gauging, and load sensing.

The sensing hub 174 may also include a data management unit 178 for data storage and retrieval, one or more processing cores 180 for computational tasks, and a communication interface 182 for coordinating with at least one processor in the processing system of the computing device. The sensing hub 174 may be configured to perform real-time data processing, use data from different sensors to derive context or develop a contextual understanding of the device's surroundings, user's condition, etc., generate composite information based on the multimodal data and context information, use the generated composite information to generate or update user profile information, generate or update an enhanced prompt, generate or update LXM output, adjust device settings, trigger specific actions on the computing device, or perform other similar operations. The derived context may include actionable information formulated through the analysis of multimodal data, which may directly influence functionalities or behaviors of the computing device and associated applications. For example, derived context could indicate physical activities such as running, triggering a tracking feature in a fitness application. Similarly, the derived context may indicate indoor or outdoor environments, vehicle usage, sleep states, meeting scenarios, emergency situations, and user moods, etc., each leading to specific, appropriate actions or settings adjustments.

The sensing hub 174 may continually capture inputs, data, and information from diverse sensors or modalities that offer a broad spectrum of multimodal data. In some embodiments, the computing device 101 may be configured to use the information collected by the sensing hub 174 in conjunction with information captured by any of the sensors and input/output devices accessible to the user to structure the enhanced prompts and content for the LXM. In some embodiments, the computing device 101 may be configured to analyze and combine data from these diverse sources to obtain comprehensive insights into the user's context when interacting with the LXM.

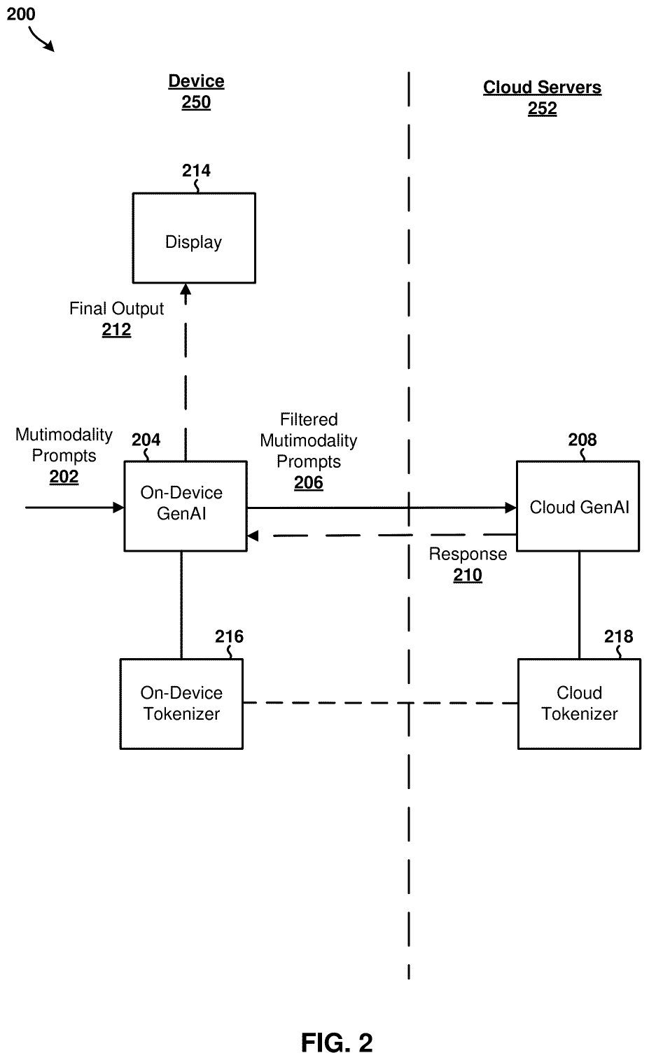

FIG. 2 illustrates example components in a distributed hybrid AI system 200 that intelligently partitions or splits processing tasks between an end-user device that includes a local LXM and cloud-based servers that implement all or portions of a cloud-based LXM in accordance with some embodiments. With reference to FIGS. 1A-2, the system 200 may include an end-user device 250 and cloud servers 252. The end-user device 250 may include a local on-device AI model 204 (On-Device GenAI), a display 214, and a local on-device tokenizer 216 component. The cloud servers 252 may include a cloud-based AI model 208 (Cloud GenAI) and a cloud tokenizer 218 component. In various embodiments, the local on-device AI model 204 and/or the cloud-based AI model 208 (Cloud GenAI) may be LXMs.

The device 250 may be configured to receive and apply multimodal prompts 202 to the local on-device AI model 204 to generate filtered multimodal prompts 206 that are sent to the cloud-based AI model 208. The multimodal prompts 202 may include a combination of inputs such as text, images, audio, and sensor data, which may be processed by the on-device AI model 204 to reduce data complexity and prioritize relevant information before transmitting to the cloud servers 252 for further analysis.

The cloud-based AI model 208 may use the received data to perform inference operations and generate inference results that include more accurate and/or relevant information. These inference results may be included in a response 210 message that is sent back to the end-user device for further refinement or direct presentation to the user. The cloud-based AI model 208 may be configured to use its robust processing and power resources and expansive datasets to perform complex computations and provide high-quality outputs that the local device may not be able to achieve independently without having a negative or user-perceivable impact on the end-user device.

In some embodiments, at least one processor executing the local on-device AI model 204 may process and integrate cloud-based inference results with locally processed data to generate a final output 212 that is tailored to the user's original input and context. The final output 212 may include answers, recommendations, or other responses tailored to the user based on the determined user intent, context information, user profile information, etc.

In some embodiments, the on-device AI model 204 may convert the tokens into simple text or a format that is supported by the cloud-based AI model 208. In some embodiments, the local on-device tokenizer 216 and the cloud tokenizer 218 components may be configured to operate using the same or highly compatible tokenization standards, protocols, conventions, or methods so that data tokenized by the on-device tokenizer 216 may be efficiently processed by the cloud-based tokenizer 218, and vice versa. The local on-device tokenizer 216 and the cloud tokenizer 218 components may be configured to work in conjunction with one another to tokenize and detokenize data in the same manner. In these embodiments, the end-user device 250 may send the filtered tokens directly to the cloud-based AI model 208 as part of the filtered multimodality prompts 206.

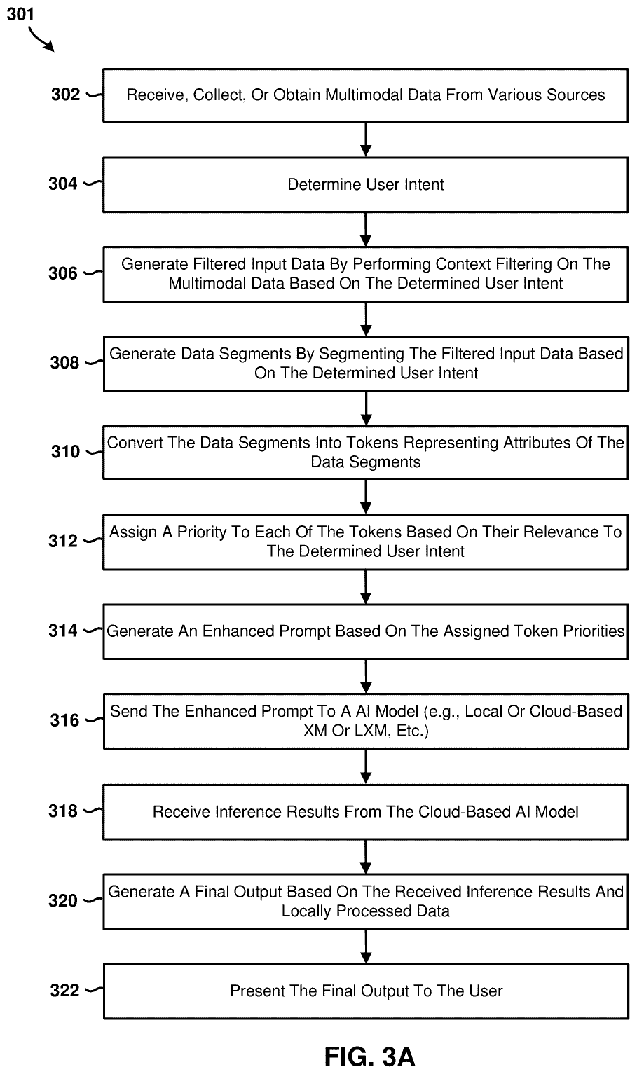

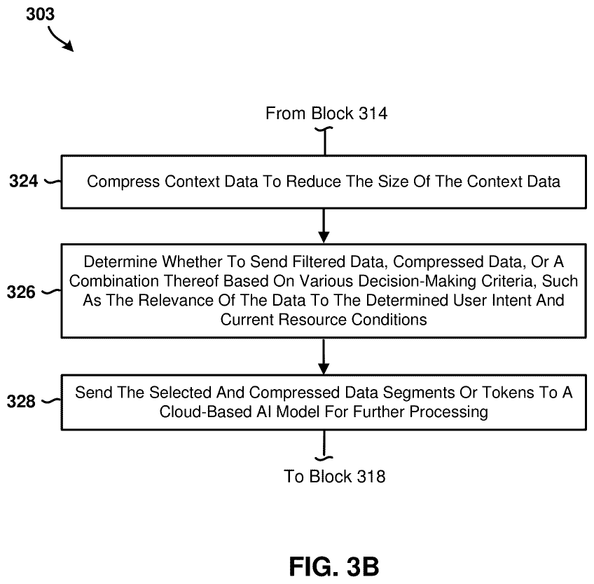

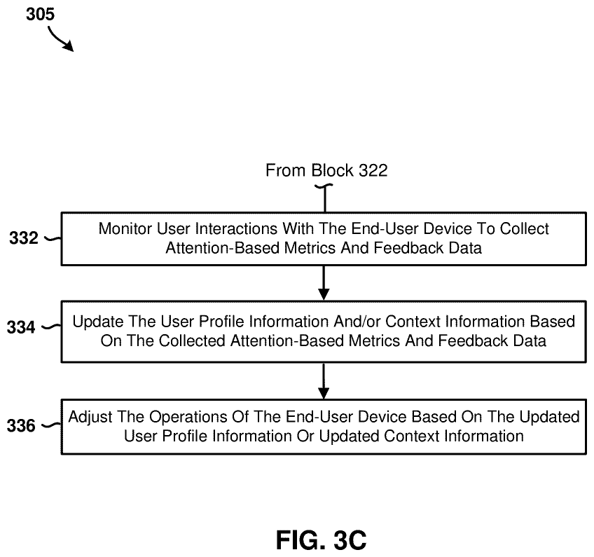

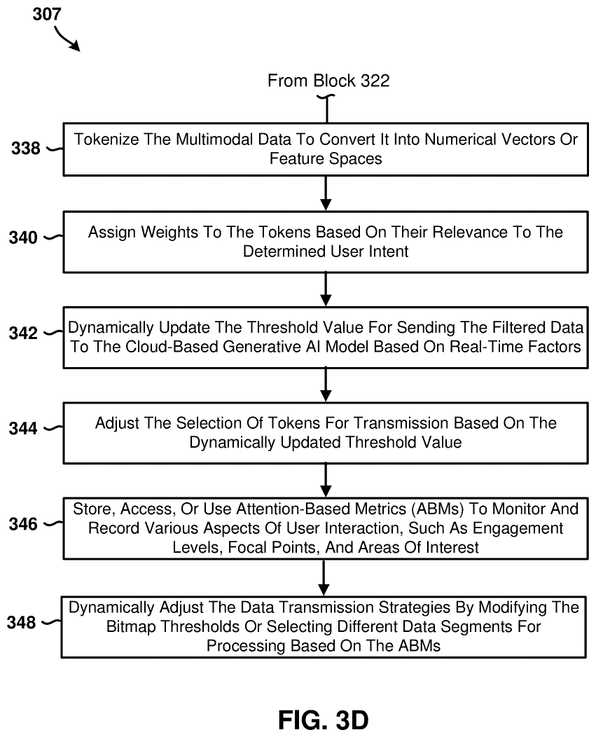

FIGS. 3A-3D are process flow diagrams illustrating methods 301, 303, 305, 307 of implementing a distributed hybrid AI system that intelligently partitions or splits processing tasks between a local LXM on the end-user device and a cloud-based LXM implemented on one or more cloud-based servers in accordance with some embodiments. With reference to FIGS. 1A-3D, the methods 301, 303, 305, 307 may be performed in a computing device by a processing system encompassing at least one processor (e.g., 110, 112, 114, 116, 118, 121, 122, 121, 122, 152, 160, 180, etc.) coupled to memory (e.g., 120, 158, etc.), and other components or subsystems discussed in this application. Means for performing the functions of the operations in methods 301, 303, 305, 307 may include a processing system including at least one processor (e.g., 110, 112, 114, 116, 118, 121, 122, 121, 122, 152, 160, 180, etc.) coupled to memory (e.g., 120, 158, etc.) and other components described herein. Further, at least one processor of a processing system may be configured with software or firmware to perform some or all of the operations of the methods 301, 303, 305, 307. In order to encompass the alternative configurations enabled in various embodiments, the hardware implementing any or all of the methods 301, 303, 305, and 307 is referred to in the descriptions of FIGS. 3A-3D as “at least one processor.”

For the sake of clarity and ease of presentation, the methods herein (e.g., 301, 303, 305, 307, etc.) are presented as separate embodiments in a specific sequence. This sequential presentation is for illustrative purposes and does not imply that the steps must be performed in the order shown. It should be clear to those skilled in the art that various combinations or omissions of these methods, blocks, operations, etc., could be used to achieve a desired result or specific outcome. Further, the descriptions herein do not preclude the integration or adaptation of different embodiments of the methods, blocks, operations, etc., to produce a modified or alternative result or solution. The presentation of individual methods, blocks, operations, etc., should not be interpreted as mutually exclusive, limiting, or as being required unless expressly recited as such in the claims.

Referring to FIG. 3A, and with reference to FIGS. 1A-2, in block 302, the at least one processor may receive, collect, or obtain multimodal data from various sources, including visual data, audio signals, sensor readings, and textual data. For example, the at least one processor may obtain visual data as images captured by a camera, audio signals recorded by a microphone, and sensor data from components such as accelerometers, gyroscopes, or GPS units within the end-user device. At least one processor in the processing system may also receive input from external devices, such as images from a surveillance camera, audio data from a voice recorder, textual commands from a keyboard, and sensor readings from an inertial measurement unit (IMU). In some embodiments, the processor may also perform initial preprocessing operations, such as noise removal, format normalization, and data preparation. In some embodiments, the at least one processor may analyze the multimodal data to identify objects within the visual data, transcribe spoken words from the audio data, interpret commands from the textual input, determine the orientation or movement of the device based on the sensor data, and perform other similar operations. In some embodiments, the at least one processor may perform attention tracking operations to monitor and record attention-based metrics (ABMs), such as user engagement and focal points, which may be used to dynamically adjust the selection and processing of the most relevant data.

In block 304, the at least one processor may determine user intent based on information available to the processor. For example, the processor may analyze the obtained multimodal data to identify patterns or contextual cues that indicate the focus or priority of the user. At least one processor in the processing system may evaluate factors such as gaze direction in the visual data, the tone or content of spoken commands in the audio data, the specific keywords or phrases in the textual input, and the movement patterns detected by the sensor data. At least one processor in the processing system may integrate these varied data points to determine or infer the user intent, such as whether the user is searching for specific information, attempting to control a device, or seeking assistance with a task. At least one processor in the processing system may use the feature space to represent the attributes of these data points and apply an AI model, such as a neural network or transformer, to analyze the relationships between them. At least one processor in the processing system may input these data points through a sequence data processing pipeline in which the inputs are tokenized, and an embedding layer converts them into high-dimensional vectors that encapsulate their contextual relationship.

In some embodiments, at least one processor in the processing system may be configured to determine the user intent based on the information available to the processor by deriving the user intent from sensory data obtained from one or more input devices. For example, at least one processor in the processing system may derive the user intent from gaze detection data obtained from augmented reality (AR) glasses worn by the user.

In some embodiments, the at least one processor may be configured to determine the user intent based on a combination of the obtained multimodal data the ABMs obtained through attention tracking. In some embodiments, the processor may use ABMs obtained through attention tracking to dynamically adjust its focus on data points that align with the user's goals, such as searching for specific information, controlling a computing device, or seeking task-related assistance. In some embodiments, the processor may refine the data using context information and user profile information. In some embodiments, the processor may generate and evaluate a bitmap to prioritize relevant data tokens based on their relevance to the user's inferred user intent.

In some embodiments, theat least one processor may use AI models or predefined heuristics to analyze the multimodal data and determine the user intent. For example, the at least one processor may apply a neural network model trained to recognize specific gestures or facial expressions captured in the visual data, correlate the recognized gestures/expressions with specific commands or inquiries detected in the audio or text data, etc.

In some embodiments, the at least one processor may be configured to use any of a variety of advanced techniques to resolve ambiguities (e.g., if the user's gaze alternates between object A and object B in an image while issuing a verbal command, etc.) or conflicting signals from different modalities in response to determining that multiple user intents could be applicable. In various embodiments, the at least one processor may be configured to use multimodal fusion, attention mechanisms, or neural networks to integrate information across modalities and identify dominant features that best represent the user intent. For example, the at least one processor may analyze the sequence of gaze shifts, the tone and content of the command, and contextual information from prior interactions to infer whether a user intends to focus on object A, object B, or both. In some embodiments, the at least one processor may weigh these factors within the AI model to prioritize the most likely user intent.

In some embodiments, the at least one processor may be configured to resolve such ambiguities by generating a hierarchical representation of potential user intents and applying attention mechanisms to prioritize the most relevant intents based on the context and user profile information. For example, the at least one processor may create a prioritized list of possible intents and assign a higher priority to intents that align more closely with the user's historical behavior or the immediate context. The system may also use reinforcement learning techniques to adapt its prioritization strategy over time and improve its accuracy in predicting user intent in complex or ambiguous scenarios.

In some embodiments, the at least one processor may be configured to prompt the user for clarification in response to determining that an ambiguity or conflicting signal may not be resolved. For example, the at least one processor may generate a query to confirm whether the user is interested in object A or object B.

In some embodiments, the at least one processor may be configured to respond to multiple intents by segmenting the multimodal data and processing each segment independently before integrating the results. For example, the system may analyze the visual data corresponding to object A separately from object B and then combine the outcomes with the analysis of the audio or textual data. These segmentation operations may allow the system to address each potential intent individually so that the final decision reflects a comprehensive analysis of all relevant data.

In block 306, the at least one processor may generate filtered input data by performing context filtering on the multimodal data based on the determined user intent to generate filtered input data. For example, the at least one processor may analyze various data types (e.g., visual data, audio signals, and sensor readings, etc.) and isolate the portions that are most relevant to the user's current objective, which may include focusing on a specific object within an image, extracting a relevant segment of an audio recording, or identifying key movements from sensor data. For example, the at least one processor may crop an image to exclude irrelevant background details in response to determining that the user intent is to identify a particular object in an image. In some embodiments, the at least one processor may be configured to generate the filtered input data based on a combination of the determined user intent and the ABMs obtained through attention tracking.

In block 308, the at least one processor may generate filtered data segments by segmenting the filtered input data based on the determined user intent. For example, the at least one processor may divide the filtered data into smaller, more manageable portions that correspond to specific aspects of the determined user intent. The segmentation may include dividing a large visual dataset into multiple sections that each focus on a distinct object of interest, or separating different components of an audio file. For example, the at least one processor may create individual segments for each of a plurality of objects within an image in response to determining, based on the determined user intent, that the user is interested in multiple objects within the image.

In some embodiments, generating the data segments to generate filtered input data may include generating bounding boxes around specific objects of interest within visual data. For example, the at least one processor may use computer vision techniques to identify objects within an image and then create bounding boxes that delineate the boundaries of each object. As another example, the at least one processor may generate bounding boxes around each detected vehicle in response to determining, based on the determined user intent, that the user intends to identify vehicles within a street scene. This may allow the system to ignore less relevant portions of the image and focus its operations on performing a more detailed analysis of the identified vehicles.

In block 310, the at least one processor may convert the filtered data segments into tokens representing attributes of the data segments. For example, the processor may analyze each data segment and extract important attributes (e.g., color, shape, or textural features from visual data, pitch and tone from audio data, etc.). At least one processor in the processing system may encode the extracted attributes into tokens that capture the important characteristics of each segment. For example, when processing an image segment that contains a car, the at least one processor may generate tokens that represent the car's color, make, model, and position within the image.

In block 312, the at least one processor may assign a priority to each of the tokens based on their relevance to the determined user intent. For example, the at least one processor may evaluate the tokens generated in block 310 and rank them according to their importance or relevance to accomplishing the determined user intent. In some embodiments, the at least one processor may assign higher priority to tokens that represent more important information, such as the primary object of interest in an image or the most salient features of an audio recording. For example, the at least one processor may assign tokens representing the vehicle's make and model a higher priority than tokens representing background elements in response to determining, based on the determined user intent, that the user is focused on identifying a specific type of vehicle.

In some embodiments, assigning a priority to each of the tokens based on their relevance to the determined user intent may include generating a bitmap that indicates the importance of each token. For example, the processor may generate or create a bitmap that visually maps the importance of each token using a binary system for hard bitmaps to mark tokens as either relevant or irrelevant (or important or not important, critical or non-critical, etc.) or a gradient system for soft bitmaps to indicate varying levels of importance.

The at least one processor may use the generated bitmap to guide the selection and prioritization of tokens for further processing or transmission. A hard bitmap may allow the device to quickly identify and retain important tokens for the next stage. In contrast, a soft bitmap may allow the device to make more nuanced decisions, allocating more resources to higher-priority tokens while still considering lower-priority tokens if needed. The at least one processor may also use the bitmap to implement dynamic data transmission strategies that adapt to changes in network bandwidth or computational resources. For example, the at least one processor may identify the tokens that should be sent to the cloud-based AI model for further analysis and the tokens that should be processed locally or discarded.

In block 314, at least one processor may generate an enhanced prompt based on the assigned token priorities. The enhanced prompt may be a refined and contextually aware version of the original user input that is stripped of extraneous or less relevant information. At least one processor in the processing system may generate the enhanced prompt by evaluating the assigned priorities of each token based on their relevance to the user's intent, context information, and user profile information. At least one processor in the processing system may select the highest-priority tokens so that the most important and relevant data is included in the enhanced prompt.

In some embodiments, the at least one processor may organize or arrange the selected tokens to improve their contribution to the inference operations. For example, the processor may sequence the tokens to preserve the contextual relationships between them so that the neural network or transformer is able to identify dependencies and correlations within the data more effectively. The system may also group tokens with similar attributes or relevance scores so that the AI model may process related information more efficiently. In addition, the at least one processor may apply dimensionality reduction techniques to the tokens to enhance computational efficiency while maintaining the critical aspects of the data. This organized structure of tokens may lead to more accurate and contextually relevant inference results by the cloud-based AI model.

In some embodiments, generating an enhanced prompt based on the assigned token priorities may include selecting tokens for transmission based on the generated bitmap and a dynamically updated threshold value for token transmission. The threshold value may operate as a filter that allows at least one processor in the processing system to modulate the number of tokens selected for transmission in real-time based on factors such as available network bandwidth, computational resources, or other external conditions. For example, the at least one processor may raise the threshold value in response to determining that bandwidth is limited or there is a high computational load so that only the most important tokens are sent to the cloud-based AI model for further processing. At least one processor in the processing system may lower the threshold when more resources become available to include more tokens, which may improve the depth and accuracy of the response generated by the cloud-based AI model. In some embodiments, the processor may generate the enhanced prompt based on the assigned token priorities and compressed context data.

In some embodiments, the at least one processor may generate an enhanced prompt based on the assigned token priorities, ABMs collected through attention tracking, and context information. By focusing on the most contextually relevant data segments indicated by the user's engagement metrics, the processor may generate the enhanced prompt to reflect the user's immediate intent more accurately.

In blocks 316 and 318, the at least one processor may send the enhanced prompt to an AI model (e.g., XM, LXM, etc.) and receive inference results from the model. As an example, the at least one processor may send an enhanced prompt to a local or remote AI model that includes a filtered and prioritized subset of data derived from the user's original input, such as key textual commands, relevant image segments, or important sensor readings. The local or cloud-based AI model may process the focused and contextually relevant prompt, leveraging its extensive computational resources and expansive data sets to generate precise and contextually appropriate inference results. These results may then be transmitted back to at least one processor in the processing system for further refinement or direct presentation to the user.

In some embodiments, sending the enhanced prompt to the AI model and receiving the inference results from the AI model in blocks 316 and 318 may include sending the enhanced prompt to a cloud-based (i.e., remote) AI model and receiving the inference results from the cloud-based AI model. In some embodiments, sending the enhanced prompt to the AI model and receiving the inference results from the AI model in blocks 316 and 318 may involve or include sending the enhanced prompt to a local AI model and receiving the inference results from the local AI model.

In block 320, the at least one processor may generate a final output based on the received inference results and locally processed data (i.e., data processed by at least one processor of the computing device). For example, the at least one processor may combine the inference results received from the cloud-based AI model with additional data processed locally on the end-user device, such as user interaction history or real-time sensor readings, to create a more accurate and contextually relevant response. This final output may include a comprehensive and tailored response that fully addresses the user's query or command.

In some embodiments, generating the final output may include integrating the received inference results with locally collected context information and user profile information. For example, the at least one processor may adjust the final output by considering the user's current location, time of day, previous interactions, and known preferences stored in the user profile. Such integration may allow at least one processor in the processing system to refine the response so that it is more personalized and aligned with the specific preferences and circumstances of the user (e.g., suggesting a nearby restaurant that matches the user's dietary preferences and is currently open).

In block 322, theat least one processor may present the final output to a user. For example, the processor may deliver the output through a visual interface (e.g., displaying directions on a map, etc.) or an auditory channel (e.g., reading out the next steps in a task, etc.). At least one processor in the processing system may select the mode and manner of presentation based on the nature of the output and the current context.

In some embodiments, presenting the final output to the user includes at least one of displaying information on an electronic display of the end-user device, providing audio feedback, or performing a responsive action. For example, the at least one processor may display detailed instructions on a smartphone screen, play an audio message through a smart speaker, or trigger a specific action to adjust the temperature on a smart thermostat based on the user's voice command.

Referring to FIG. 3B, and with reference to FIGS. 1A-3A, in blocks 302-314, the at least one processor may perform the operations of blocks 302-314 as described.

In block 324, the at least one processor may compress context data to reduce the size of the context data. Such compression may be important for managing bandwidth and processing resources efficiently, especially when handling large volumes of data. For example, the at least one processor may apply lossless or lossy compression techniques depending on the data type to reduce the size of the data while preserving the most important information. This may allow for quicker data transmission or processing without compromising data integrity.

In some embodiments, compressing the context data may include cropping an image to highlight the area of interest and compressing the cropped image before transmission to reduce data size and improve resource usage. For example, the processor may determine that the user's query relates to a specific object (e.g., a car, etc.) within an image, crop the image to filter out irrelevant background data, and use image compression techniques to further compress the cropped image before its inclusion in the enhanced prompt.

In block 326, the at least one processor may determine whether to send filtered data, compressed data, or a combination thereof based on various decision-making criteria, such as the relevance of the data to the determined user intent and current network conditions. For example, highly relevant data may be transmitted with minimal compression, while less relevant data may be heavily compressed or filtered out entirely.

In some embodiments, the at least one processor may implement a combination of communication strategies (e.g., sending tokens directly, bitmap-based selection, compression, etc.) to transmit the most relevant information to the cloud-based AI model. For example, the at least one processor may use a bitmap to prioritize which tokens or data segments to transmit and selectively apply compression based on the available bandwidth and the relevance of the information.

In block 328, the at least one processor may send the selected and compressed data segments or tokens to a cloud-based AI model for further processing. For example, after compressing and selecting the most relevant data, the processor may transmit the selected segments to the cloud-based AI model for more complex analysis.

The cloud-based AI model may use the received data to perform inference operations and generate more accurate or contextually relevant information. The inference results are then sent back to the local processing system for further refinement or direct presentation to the user. For example, the cloud-based AI model may analyze the data to generate insights, predictions, or responses that are combined with local context data before being presented to the user as the final output.

In blocks 318-322, the at least one processor may perform the operations of blocks 318-322 as described.

Referring to FIG. 3C, and with reference to FIGS. 1A-3B, in blocks 302-322, the at least one processor may perform the operations of blocks 302-322 as described.

In block 332, the at least one processor may monitor user interactions with the end-user device to collect attention-based metrics and feedback data. At least one processor in the processing system may use sensors, input devices, and software logs to track various user activities, such as gaze direction, touch inputs, and interaction patterns. For example, the at least one processor may monitor the user's eye movements via a camera to determine where the user is focusing on the screen or analyze the frequency and type of interactions with the device (e.g., clicks, taps, etc.) to gauge user engagement. At least one processor in the processing system may gather data that reflects the current focus or interest of the user and may be used to enhance the relevance and personalization of the responses.

In block 334, the at least one processor may update the user profile information and/or context information based on the collected attention-based metrics and feedback data. At least one processor in the processing system may analyze the attention-based metrics to identify changes in user preferences, behavior, or environment and update the user profile or contextual information accordingly. For example, the at least one processor may update the user profile to reflect a preference for specific types of content in response to determining that the user frequently interacts with those content types. Similarly, the at least one processor may update the context information so that future responses are tailored to the current situation in response to detecting changes in context (e.g., changes in location, activity level, etc.).

In block 336, the at least one processor may adjust the operations of the end-user device based on the updated user profile information or updated context information. At least one processor in the processing system may use the updated data to refine how it processes user inputs, prioritizes tasks, or allocates resources. For example, the at least one processor may change the way it prioritizes incoming data tokens based on the user's updated preferences so that the most relevant information is processed first. At least one processor in the processing system may reduce the quality of transmitted data to improve performance in response to determining, based on the context information, that the user is in a low-bandwidth environment.

In some embodiments, adjusting the operations of the end-user device may include modifying token prioritization, data transmission strategies, or response generation methods to align with the updated user profile or context information. At least one processor in the processing system may reconfigure its internal processes based on user expectations and environmental constraints. For example, the at least one processor may prioritize certain tokens that are more relevant to the user's recent activities or adjust the data transmission strategy to send more detailed information when network conditions are favorable.

In some embodiments, the at least one processor may be configured to monitor user interactions with the end-user device to collect attention-based metrics and feedback data, update the user profile information and/or context information based on the collected attention-based metrics and feedback data, and adjust the operations of the end-user device based on the updated user profile or updated context information. At least one processor in the processing system may repeatedly or continuously refine its understanding of the user and environment and dynamically adjust its operations accordingly. For example, the at least one processor may collect and analyze attention-based metrics, determine that there has been a shift in the user's focus toward certain content types, and update the user profile to reflect updated user preferences.

In some embodiments, the at least one processor may be configured to dynamically update the threshold value based on network bandwidth, computational resources, or communication costs. For example, the at least one processor may increase or raise the threshold to allow fewer tokens to be transmitted to the cloud-based AI model in response to determining that network bandwidth is limited.

Referring to FIG. 3D, and with reference to FIGS. 1A-3C, in blocks 302-322, the at least one processor may perform the operations of blocks 302-322 as described.

In block 338, the at least one processor may tokenize the multimodal data to convert it into numerical vectors or feature spaces representing specific attributes or characteristics of the original multimodal data. At least one processor in the processing system may use techniques such as natural language processing (NLP) for textual data, signal processing for audio data, and computer vision algorithms for visual data to break down complex data into manageable units or tokens. For example, the at least one processor may convert a paragraph of text into individual word tokens, each represented as a vector that captures semantic meaning. At least one processor in the processing system may segment an image into pixel blocks that are each represented by a vector indicating color and texture attributes. Such tokenization operation may allow at least one processor in the processing system to analyze and manipulate data at a granular level and facilitate more precise processing in subsequent operations.

In block 340, the at least one processor may assign weights to the tokens based on their relevance to the determined user intent, focus, or priority. At least one processor in the processing system may evaluate the context and user preferences to determine which tokens are most important for achieving the user's goals. For example, the processor may assign higher weights to keywords directly related to the user's query and assign lower weights to less relevant words.

In some embodiments, assigning weights to the tokens may include scoring the tokens. At least one processor in the processing system may determine a score for each token based on factors such as relevance, frequency, or significance within the context of the user's query. In some embodiments, higher scores may indicate that a token is more important and should be prioritized during analysis and transmission. For example, the at least one processor may assign higher scores to tokens related to a specific product feature that the user inquired about. In some embodiments, lower scores may indicate that a token is more important and should be prioritized during analysis and transmission.

In block 342, the at least one processor may dynamically update the threshold value for sending the filtered data to the cloud-based generative AI model based on real-time factors. In some embodiments, the at least one processor may continuously monitor and evaluate real-time factors such as network bandwidth, computational resources, and communication costs to make better and more informed decisions about data transmission and processing, such as whether to adjust the threshold to increase or decrease the amount of data that is sent to the cloud.

In block 344, the at least one processor may adjust the selection of tokens for transmission based on the dynamically updated threshold value. At least one processor in the processing system may reevaluate which tokens should be transmitted based on the current threshold. In some embodiments, adjusting the selection of tokens may include modifying token prioritization, data transmission strategies, or compression methods to align with the updated threshold value.

In block 346, the at least one processor may store, access, or use attention-based metrics (ABMs) to monitor and record various aspects of user interaction, such as engagement levels, focal points, and areas of interest. For example, the at least one processor may analyze eye-tracking data to determine which parts of the screen the user is focusing on or may track the amount of time a user spends on specific tasks or content areas. These metrics may then be used to identify the user's current interests or needs, allowing the system to adjust its responses or prioritize certain types of information in subsequent interactions.

In block 348, the at least one processor may dynamically adjust the data transmission strategies by modifying the bitmap thresholds or selecting different data segments for processing based on the ABMs. For example, theat least one processor may increase the bitmap threshold to prioritize the transmission of tokens or data segments that correspond to the areas of the screen where the user has shown the most interest, as indicated by higher engagement levels or focused attention. At least one processor in the processing system may lower the threshold for less relevant areas to reduce the amount of data associated with those segments that is sent to the cloud.

In some embodiments, adjusting the data transmission strategies may include aligning the selected data segments with the current user engagement levels, focal points, or areas of interest as indicated by the ABMs. For example, the at least one processor may prioritize data segments that correspond to the portions of a visual display where the user's gaze is concentrated, as determined by eye-tracking metrics. At least one processor in the processing system may ensure that the data related to a particular object or region of the screen on which the user is currently focused is transmitted with higher priority.

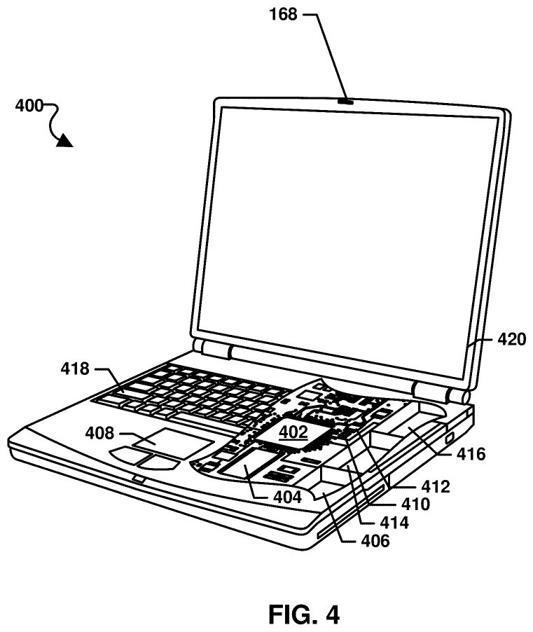

Various embodiments (including, but not limited to, embodiments described above with reference to FIGS. 1A-3D) may be implemented in a wide variety of wireless devices and computing systems, including a laptop computer 400, an example of which is illustrated in FIG. 4. With reference to FIGS. 1-4, a laptop computer 400 may include a processing system 402 coupled to volatile memory 404 and a large-capacity nonvolatile memory, such as a disk drive 406 or flash memory. The laptop computer 400 may include a touchpad 408 that serves as the computer's pointing device, providing input to at least one processor in the processing system 402 through drag, scroll, and flick gestures. At least one processor in the processing system 402 may be configured to process data from both the user-facing camera 168 and the touchpad 408 to track the user's attention to content displayed on the electronic display screen 420. These tracking capabilities may improve user interaction by adapting the displayed content or system responses based on the user's focus and engagement, such as by using the user intent determination and/or attention-tracking techniques as discussed.

In addition, the laptop computer 400 may include one or more antennas 410 for sending and receiving electromagnetic signals. These antennas may be connected to a wireless data link and/or a cellular transceiver 412, both of which may be coupled to the processor or processing system 402. The laptop may also include a Bluetooth (BT) transceiver 414, a solid-state drive (SSD) 416, a keyboard 418, and a display 420, all connected to at least one processor in the processing system 402. Other configurations may include additional input devices, such as a computer mouse or trackball connected via a Universal Serial Bus (USB) or other interfaces, which may also be compatible with various embodiments described herein.

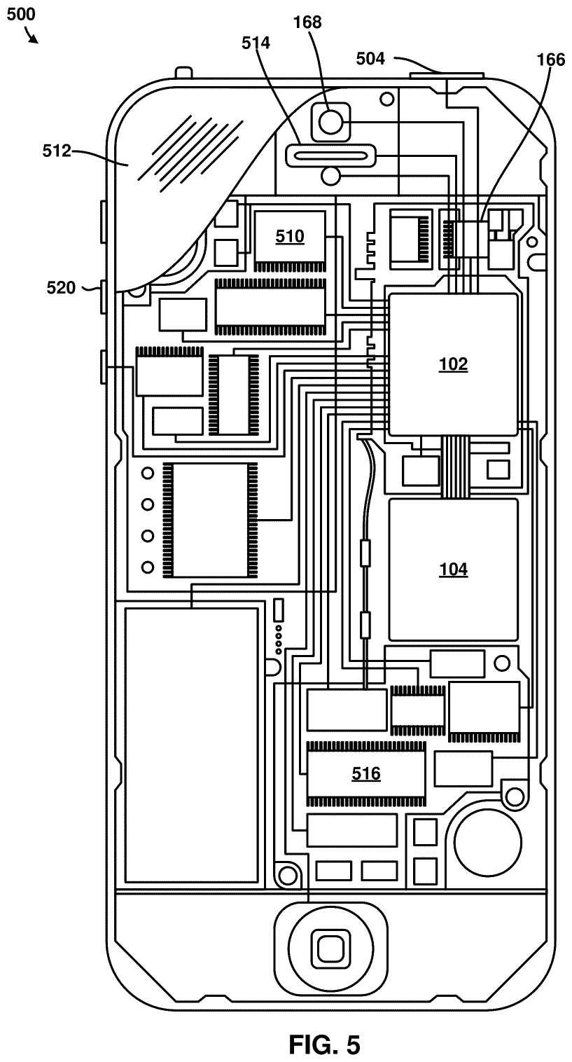

FIG. 5 is a component block diagram of a computing device 500 suitable for use with various embodiments. With reference to FIGS. 1-5, various embodiments may be implemented on a variety of computing devices 500, an example of which is illustrated in FIG. 5 in the form of a smartphone. The computing device 500 may include a first SOC 102 and a second SOC 104, both of which are coupled to internal memory 516, a touch-sensitive display 512, a speaker 514, and a user-facing camera 168. The first and second SoCs 102, 104 may be configured to process data from the user-facing camera 168 and/or the touch-sensitive display 512 to implement advanced features such as attention tracking, which monitors the user's focus on content displayed on the touch-sensitive display 512. The first and second SoCs 102, 104 may also interface with at least one subscriber identity module (SIM) or a SIM interface that may store information supporting multiple 5GNR subscriptions and enabling service on a 5G non-standalone (NSA) network.

The computing device 500 may include an antenna 504 for sending and receiving electromagnetic radiation that may be connected to a wireless transceiver 166 integrated in or coupled to one or more processors in the first and/or second SOCs 102, 104. The computing device 500 may also include user interface components, such as menu selection buttons or rocker switches 520, for receiving user inputs.

The computing device 500 also includes a sound encoding/decoding (CODEC) circuit 510 that digitizes audio input received from a microphone into data packets suitable for wireless transmission and decodes incoming sound data packets to produce analog signals, which are then output through the speaker 514. Also, one or more of the processors in the first and second SoCs 102, 104, wireless transceiver 166, and CODEC 510 may include integrated digital signal processing (DSP) circuits to handle complex signal processing tasks.

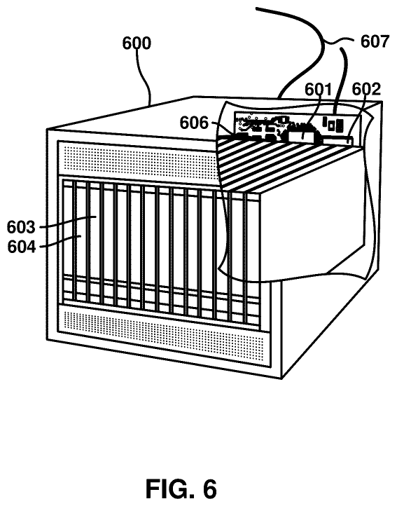

Some embodiments may be implemented on any of a variety of commercially available computing devices, such as the server computing device 600 illustrated in FIG. 6. Such a server device 600 may include a processor 601 coupled to volatile memory 602 and a large capacity nonvolatile memory, such as a disk drive 603. The server device 600 may also include a floppy disc drive, USB, etc. coupled to the processor 601. The server device 600 may also include network access ports 606 coupled to the processor 601 for establishing data connections with a network connection circuit 604 and a communication network 607 (e.g., an Internet protocol (IP) network) coupled to other communication system network elements.

The processors or processing units discussed in this application may be any programmable microprocessor, microcomputer, or multiple processor chip or chips that can be configured by software instructions (applications) to perform a variety of functions, including the functions of various embodiments described. In some computing devices, multiple processors may be provided, such as one processor within the first circuitry dedicated to wireless communication functions and one processor within the second circuitry dedicated to running other applications. Software applications may be stored in the memory before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing device or computing system including at least one processor coupled to memory and configured (e.g., with processor-executable instructions) to perform operations of the methods of the following implementation examples; the example methods discussed in the following paragraphs implemented by a computing system including means for performing functions of the methods of the following implementation examples; and the example methods discussed in the following paragraphs may be implemented as a non-transitory processor-readable storage medium having stored thereon processor-executable instructions configured to cause a processor of a computing system to perform the operations of the methods of the following implementation examples.
Example 1: A method performed by a processor of an end-user device of applying multimodal data to a generative artificial intelligence (AI) model, including receiving multimodal data, determining user intent based on information available to the processor, generating filtered input data by performing context filtering on the multimodal data based on the determined user intent, generating data segments by segmenting the filtered input data based on the determined user intent, converting the data segments into tokens representing attributes of the data segments, assigning a priority to each of the tokens based on their relevance to the determined user intent, generating an enhanced prompt based on the assigned token priorities, sending the enhanced prompt to an AI model, receiving inference results from the AI model, generating a final output based on the received inference results and locally processed data, and presenting the final output to a user.
Example 2: The method of example 1, in which assigning a priority to each of the tokens based on their relevance to the determined user intent includes generating a bitmap indicating importance of each token, the generated bitmap including at least one of a hard bitmap that includes binary values, or a soft bitmap that includes a range of values, and generating an enhanced prompt based on the assigned token priorities includes selecting tokens for transmission based on the generated bitmap and a dynamically updated threshold value for token transmission.
Example 3: The method of any of the examples 1 and 2, further including adjusting the dynamically updated threshold value based on at least one of battery life, network bandwidth, computational resources, or communication costs.
Example 4: The method of any of the examples 1-3, in which receiving the multimodal data includes receiving at least two or more of visual data, auditory data, textual data, or sensor data.
Example 5: The method of any of the examples 1-4, in which generating the data segments by segmenting the filtered input data based on the determined user intent includes generating bounding boxes around specific objects of interest within visual data based on the determined user intent.
Example 6: The method of any of the examples 1-5, further including compressing context data to reduce a data size of the context data in response to determining that a large volume of the context data is relevant to the determined user intent, in which generating the enhanced prompt based on the assigned token priorities includes generating the enhanced prompt based on the assigned token priorities and the compressed context data.
Example 7: The method of any of the examples 1-6, in which generating the final output includes integrating the inference results with locally collected context information and user profile information.
Example 8: The method of any of the examples 1-7, in which presenting the final output to the user includes at least one of displaying information on an electronic display of the end-user device, providing audio feedback, or performing a responsive action.
Example 9: The method of any of the examples 1-8, further including monitoring user interactions with the end-user device to collect attention-based metrics and feedback data and updating user profile information or context information based on the collected attention-based metrics and feedback data.
Example 10: The method of any of the examples 1-9, further including adjusting operations of the end-user device based on the updated user profile information or the updated context information.
Example 11: The method of any of the examples 1-10, in which determining the user intent based on the information available to the processor further includes deriving the user intent from sensory data obtained from one or more input devices.
Example 12: The method of any of the examples 1-11, in which deriving the user intent from the sensory data obtained from one or more input devices includes deriving the user intent from gaze detection data obtained from augmented reality (AR) glasses worn by the user.
Example 13: The method of any of the examples 1-12, in which sending the enhanced prompt to the AI model and receiving the inference results from the AI model includes sending the enhanced prompt to a cloud-based AI model and receiving the inference results from the cloud-based AI model.
Example 14: The method of any of the examples 1-13, in which sending the enhanced prompt to the AI model and receiving the inference results from the AI model includes sending the enhanced prompt to a local AI model and receiving the inference results from the local AI model.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing system and the computing system may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different types of memories and memory technologies are available or contemplated in the future, any or all of which may be included and used in systems and computing systems that implement the various embodiments. Such memory technologies/types may include non-volatile random-access memories (NVRAM) such as Magnetoresistive RAM (M-RAM), resistive random access memory (ReRAM or RRAM), phase-change random-access memory (PC-RAM, PRAM or PCM), ferroelectric RAM (F-RAM), spin-transfer torque magnetoresistive random-access memory (STT-MRAM), and three-dimensional cross point (3D-XPOINT) memory. Such memory technologies/types may also include non-volatile or read-only memory (ROM) technologies, such as programmable read-only memory (PROM), field programmable read-only memory (FPROM), one-time programmable non-volatile memory (OTP NVM). Such memory technologies/types may further include volatile random-access memory (RAM) technologies, such as dynamic random-access memory (DRAM), double data rate (DDR) synchronous dynamic random-access memory (DDR SDRAM), static random-access memory (SRAM), and pseudo static random-access memory (PSRAM). Systems and computing systems that implement the various embodiments may also include or use electronic (solid-state) non-volatile computer storage mediums, such as FLASH memory. Each of the above-mentioned memory technologies include, for example, elements suitable for storing instructions, programs, control signals, and/or data for use in a computing system, system on chip (SOC) or other electronic component. Any references to terminology and/or technical details related to an individual type of memory, interface, standard or memory technology are for illustrative purposes only, and not intended to limit the scope of the claims to a particular memory system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with various embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with various embodiments disclosed herein may be implemented or performed with a general purpose processor, a digital signal processor (DSP), an application specific integrated circuit (TCUASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing systems, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store target program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. In addition, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to various embodiments shown herein but is to be accorded the widest scope consistent with the following claims and the principles and novel features disclosed herein.

What is claimed is:

1. A computing device, comprising:
at least one memory; and
at least one processor coupled to the at least one memory and configured to:
receive multimodal data;
determine user intent based on information available to the at least one processor;
generate filtered input data by performing context filtering on the multimodal data based on the determined user intent to generate filtered input data;
generate filtered data segments by segmenting the filtered input data based on the determined user intent;
convert the filtered data segments into tokens representing attributes of the data segments;
assign a priority to each of the tokens based on their relevance to the determined user intent;
generate an enhanced prompt based on the assigned token priorities;
send the enhanced prompt to an artificial intelligence (AI) model;
receive inference results from the AI model;
generate a final output based on the received inference results and locally processed data; and
present the final output to a user.

2. The computing device of claim 1, wherein the at least one processor is configured to:
assign a priority to each of the tokens based on their relevance to the determined user intent by generating a bitmap indicating importance of each token, the generated bitmap including at least one of:
a hard bitmap that includes binary values; or
a soft bitmap that includes a range of values; and
generate the enhanced prompt based on the assigned token priorities by selecting tokens for transmission based on the generated bitmap and a dynamically updated threshold value for token transmission.

3. The computing device of claim 2, wherein the at least one processor is further configured to adjust the dynamically updated threshold value based on at least one of:
battery life;
network bandwidth;
computational resources; or
communication costs.

4. The computing device of claim 1, wherein the at least one processor is configured to receive the multimodal data by receiving at least two or more of:
visual data;
auditory data;
textual data; or
sensor data.

5. The computing device of claim 1, wherein the at least one processor is configured to generate the filtered data segments by segmenting the filtered input data based on the determined user intent by:
generating bounding boxes around specific objects of interest within visual data based on the determined user intent.

6. The computing device of claim 1, wherein:
the at least one processor is further configured to compress context data to reduce a data size of the context data in response to determining that a large volume of the context data is relevant to the determined user intent; and
the at least one processor is configured to generate the enhanced prompt based on the assigned token priorities by generating the enhanced prompt based on the assigned token priorities and the compressed context data.

7. The computing device of claim 1, wherein the at least one processor is configured to generate the final output by integrating the inference results with locally collected context information and user profile information.

8. The computing device of claim 1, wherein the at least one processor is configured to present the final output to the user includes at least one of:
displaying information on an electronic display of the end-user device;
providing audio feedback; or
performing a responsive action.

9. The computing device of claim 1, wherein the at least one processor is further configured to:
monitor user interactions with the end-user device to collect attention-based metrics and feedback data; and
update user profile information or context information based on the collected attention-based metrics and feedback data.

10. The computing device of claim 9, further comprising adjusting operations of the end-user device based on the updated user profile information or the updated context information.

11. The computing device of claim 1, wherein the at least one processor is configured to determine the user intent based on the information available to the processor by deriving the user intent from sensory data obtained from one or more input devices.

12. The computing device of claim 11, wherein the at least one processor is configured to derive the user intent from the sensory data obtained from one or more input devices by deriving the user intent from gaze detection data obtained from augmented reality (AR) glasses worn by the user.

13. The computing device of claim 1, wherein the at least one processor is configured to send the enhanced prompt to the AI model and receive the inference results from the AI model by sending the enhanced prompt to a cloud-based AI model and receiving the inference results from the cloud-based AI model.

14. The computing device of claim 1, wherein the at least one processor is configured to send the enhanced prompt to the AI model and receive the inference results from the AI model by sending the enhanced prompt to a local AI model and receiving the inference results from the local AI model.

15. A method performed by a processor of an end-user computing device of applying multimodal data to an artificial intelligence (AI) model, the method comprising:
receiving multimodal data;
determining user intent based on information available to the processor;
generating filtered input data by performing context filtering on the multimodal data based on the determined user intent to generate filtered input data;
generating filtered data segments by segmenting the filtered input data based on the determined user intent;
converting the filtered data segments into tokens representing attributes of the data segments;
assigning a priority to each of the tokens based on their relevance to the determined user intent;
generating an enhanced prompt based on the assigned token priorities;
sending the enhanced prompt to an AI model;
receiving inference results from the AI model;
generating a final output based on the received inference results and locally processed data; and
presenting the final output to a user.

16. The method of claim 15, wherein:
assigning a priority to each of the tokens based on their relevance to the determined user intent comprises generating a bitmap indicating importance of each token, the generated bitmap including at least one of:
a hard bitmap that includes binary values; or
a soft bitmap that includes a range of values; and
generating the enhanced prompt based on the assigned token priorities comprises selecting tokens for transmission based on the generated bitmap and a dynamically updated threshold value for token transmission.

17. The method of claim 15, wherein generating the filtered data segments by segmenting the filtered input data based on the determined user intent comprises:
generating bounding boxes around specific objects of interest within visual data based on the determined user intent.

18. The method of claim 15, wherein generating the final output comprises integrating the inference results with locally collected context information and user profile information.

19. The method of claim 15, wherein sending the enhanced prompt to the AI model and receiving the inference results from the AI model comprise at least one or more of:
sending the enhanced prompt to a cloud-based AI model and receiving the inference results from the cloud-based AI model; or
sending the enhanced prompt to a local AI model and receiving the inference results from the local AI model.

20. A non-transitory processor-readable medium having stored thereon processor-readable instructions configured to cause a processor of a computing device to perform operations comprising:
receiving multimodal data;
determining user intent based on information available to the processor;
generating filtered input data by performing context filtering on the multimodal data based on the determined user intent to generate filtered input data;
generating filtered data segments by segmenting the filtered input data based on the determined user intent;
converting the filtered data segments into tokens representing attributes of the data segments;
assigning a priority to each of the tokens based on their relevance to the determined user intent;
generating an enhanced prompt based on the assigned token priorities;
sending the enhanced prompt to a local or remote artificial intelligence (AI) model;
receiving inference results from the AI model;
generating a final output based on the received inference results and locally processed data; and
presenting the final output to a user.
